(19) United States
(12) Patent Application Publication
(10) Pub. No.: US 2012/0252578 A1
(43) Pub. Date: Oct. 4, 2012

(54) GAME DEVICE, GAME CONTROL METHOD, AND NON-TRANSITORY INFRMATION RECORDING MEDIUM ON WHICH A COMPUTER READABLE PROGRAM IS RECORDED

(75) Inventors: Ryo OZAKI, Tokyo (JP); Akira KANKE, Tokyo (JP); Yutaka NEGISHI, Tokyo (JP)

(73) Assignee: KONAMI DIGITAL ENTERTAINMENT CO., LTD., Tokyo (JP)

(21) Appl. No.: 13/435,467

(22) Filed: Mar. 30, 2012

(30) Foreign Application Priority Data
Mar. 31, 2011 (JP) 2011-079376

(51) Int. Cl. A63F 13/02; A63F 13/12

(52) U.S. Cl. 463/36

(57) ABSTRACT

A texture generator generates an image, for which mosaic processing has been performed on an acquired image, as a texture candidate. A color acquirer acquires a candidate symbol color. A performance parameter acquirer finds a performance parameter from the similarity between a candidate symbol color and a point symbol color. A performance parameter presenter presents the performance parameter that was found to a user. A confirmation instruction receiver receives a confirmation instruction from the user. A texture confirmer that, when a confirmation instruction is received, confirms the texture candidate as the texture to be applied to a character.

### CROSS-REFERENCE TO RELATED APPLICATION

This application claims the benefit of Japanese Patent Application No. 2011-079376, filed on Mar. 31, 2011, the entire disclosure of which is incorporated by reference herein.

### FIELD

This application relates generally to a game device, which allows the appearance of a character in virtual space to be that of an image taken by a camera, a game control method, and a non-transitory information recording medium on which is recorded a computer readable program that makes the game device and game control method possible by way of a computer.

### BACKGROUND

Action games are known wherein the behavior of a character that exists in virtual space and is the main character of the game is controlled by operations performed by a user using a controller that is connected to a game device. Recently, action games are known, for example, wherein, in virtual space, a character is caused to infiltrate into an enemy stronghold for intelligence while hiding oneself.

In this kind of action games, the form of the appearance of the character in virtual space can affect the score of the game. For example, the more difficult the character's appearance is for the enemy to discover, the probability of the enemy discovering the character decreases, and it is possible for the game score to improve. Elements used for determining the appearance of a character could be, for example, the camouflage pattern or color of the camouflaged clothes worn by the character.

The camouflaged clothes worn by the character can be selected by the user from among candidates of various kinds of camouflaged clothes that were prepared beforehand, or can be automatically processed to correspond with the progression of the game or the background including virtual surroundings of the main character. For example, in Unexamined Japanese Patent Application Kokai Publication No. 2007-260197, technology is disclosed wherein the camouflage pattern and texture of the camouflaged clothes worn by the character are changed according to the virtual surroundings of the character.

Incidentally, in the technology disclosed in Unexamined Japanese Patent Application Kokai Publication No. 2007-260197, the camouflaged clothes desired by the user are not necessarily the clothes that are used as the camouflaged clothes worn by the character. Moreover, even in the case where the user selects the camouflaged clothes, the camouflaged clothes desired by the user may not be included among the candidates of the various kinds of camouflaged clothes that are prepared in advance. Therefore, taking into consideration the probability of the enemy detecting the character, the user may have a strong desire to freely create camouflaged clothes to be worn by the character in virtual space.

### SUMMARY

In consideration of the problem above, an object of the present invention is to provide a game device, which allows modification of the appearance of a character in virtual space to be based on an image taken by a camera, a game control method, and a non-transitory information recording medium on which is recorded a computer readable program that makes the game device and game control method possible by way of a computer.

In order to accomplish the object above, the game device of a first aspect of the present invention comprises an image acquirer, a candidate generator, a color acquirer, a performance parameter acquirer, and performance parameter presenter, a confirmation instruction receiver and a texture confirmer.

First, the image acquirer acquires an image taken by a camera. The image that is acquired can be an image that is taken by an internal camera inside the game device, or can be an image that is taken by an external camera. An image that expresses background including virtual surroundings such as a forest, field, river, city and the like can be used as the image that is acquired.

The candidate generator generates an image for which mosaic processing has been performed on the acquired image, and designates the generated image as a candidate for texture to be applied to a character in virtual space. The character is typically the main character in a virtual space that is operated by the user. Here, the texture that is applied to the character, for example, is applied to create camouflaged clothes that are worn by the character. In other words, the candidate generator designates the color or pattern that was obtained by performing mosaic processing to the acquired image as a color or pattern candidate for camouflaged clothes to be worn by the character.

Here, when mosaic processing is not performed on the acquired image, there is a possibility that texture having an unsuitable pattern will be generated. An unsuitable pattern, for example, is a pattern with too much contrast, or a pattern that includes unsuitable characters (for example, characters that express proper nouns, or characters that express obscene language). Therefore, instead of the acquired image, the candidate generator designates an image, for which mosaic processing has been performed on the acquired image, as a candidate for the texture to be applied to a clothing of the character.

Mosaic processing, for example, is a process that divides an image into groups by dividing all of the pixels of the image into the vertical direction and horizontal direction. Then for each group, takes the brightness value of all of the pixels included inside each group to be the average value of the brightness values of all of the pixels included inside that group.

Next, the color acquirer acquires a color that symbolizes the generated texture candidate. The color that symbolizes the texture candidate, for example, when considering the texture as one image, can be defined as in (A) to (C) below.

(A) Color of a preset pixel (for example, the pixel in the center, or a pixel in one of the four corners).

(B) Color of a randomly set pixel (for example, the pixel at coordinates corresponding to numbers that were generated by a random number generator).

(C) Intermediate color between the colors of a plurality of pixels such as preset pixels or randomly set pixels. (For example, a color represented by the average value of the brightness value of the pixels in the center and of the pixels in the four corners. The average value can be a simple average, or can be a weighted average.)

Moreover, the color that symbolizes the texture candidate can be one (one color), or can be more than one (plurality of colors)

The performance parameter acquirer finds a performance parameter for the texture candidate from the similarity between the acquired color and a color that symbolizes a point of interest in the virtual space. The point of interest, for example, can be a point in virtual space in the direction the character is going (a point further in the back of the screen than the character). In that case, the color that symbolizes the point of interest, for example, can be the color of an object (an object that is located further in the back of the screen than the character) in virtual space that is in the direction of advancement of the character. In the embodiments, the color that symbolizes the point of interest is correlated with the topography of the point of interest and is set beforehand.

The color that symbolizes the point of interest, for example, can be a color that is defined by (A) to (C) above when the background displayed on the screen is represented by an image. The color symbolizing the point of interest can be one color, or can be a plurality of colors. Furthermore, there can be a plurality of points of interest. In that case, a color symbolizing a point of interest is prepared for each point of interest.

The similarity between the color that symbolizes the texture candidate and the color that symbolizes the point of interest can be defined in any way. For example, when there is one color that symbolizes the texture candidate and one color that symbolizes the point of interest, the similarity can be expressed by the inverse of the greatest difference in brightness values of the differences in brightness values of the three primary colors (red, green and blue). Alternatively, the similarity can be expressed by the inverse of the sum of the differences of the brightness values of the three primary colors (red, green and blue). More specifically, when the brightness values of the three primary colors of the color that symbolizes the texture candidate are expressed as (Xr, Xg, Xb), and the brightness values of the three primary colors of the color that symbolizes the point of interest is expressed as (Yr, Yg, Yb), the similarity can be expressed as 1/(|Xr−Yr|+|Xg−Yg| |Xb−Yb|). Here, it can be considered that the larger the inverse of the total of the difference between the brightness values of the three primary colors is, the higher the similarity is. However, when the color that symbolizes the texture candidate and the color that symbolizes the point of interest are exactly the same color, the similarity becomes ∞.

When one or both of the colors symbolizing the texture candidate and the color symbolizing point of interest is two or more colors, then, for example, the overall similarity can be set based on the specified number of similarities selected from the similarities that were found for all combinations of colors. Here, an example is given wherein there are two colors, X1 and X2, that symbolize the texture candidate, and there are two colors, Y1 and Y2, that symbolize the point of interest, and the similarity is set by selecting the two highest similarities. First, similarities are found for all color combinations. More specifically, the similarity Z11 is found for the combination X1 and Y1, the similarity Z12 is found for the combination X1 and Y2, the similarity Z21 is found for the combination X2 and Y1, and the similarity Z22 is found for the combination X2 and Y2. Here, when it is presumed that Z11>Z22>Z21>Z12, the overall similarity becomes Z11+Z22.

Here, the performance parameter for the texture candidate is found from the similarity. For example, the performance parameter is found so that the greater the similarity is, the higher the performance parameter becomes. However, elements other than the similarity can also be considered when finding the performance parameter.

For example, in an action game in virtual space where a character infiltrates an enemy stronghold, the performance parameter can be the probability that the enemy will not discover the character. Here, the similarity can be considered to be the degree to which the color and pattern of the camouflaged clothes worn by the character blend in with the color and pattern of the objects around the character. Therefore, the greater the similarity is, the more difficult it is for the enemy to discover the character.

Moreover, in a game in virtual space wherein a character appears on a stage to dance or sing for an audition, the performance parameter can be how fashionable the clothes worn by the character are. Here, the similarity can be considered the degree to which the color and pattern of the clothes worn by the character match the objects around the character. Therefore, the greater the similarity is, the higher the level of being fashionable is.

Next, the performance parameter presenter presents the performance parameter that was found to the user. The method for presenting the performance parameter to the user is arbitrary. For example, a character string that expresses the performance parameter can be displayed on the screen, or sound that expresses the performance parameter can be outputted from a speaker. From this presentation, the user is able to know the performance parameter of the current texture candidate.

The confirmation instruction receiver receives a confirmation instruction from the user. The confirmation instruction that is received from the user, for example, is the operation of pushing buttons of the game device. When the user is satisfied with the presented performance parameter, a confirmation instruction is performed, and when the user is not satisfied with the presented performance parameter, a confirmation instruction is not performed.

Here, when a confirmation instruction is received, the texture confirmer confirms the texture candidate as the texture to be applied to the clothing of the character. When a confirmation instruction is not received, the next image is acquired, and the next texture candidate is generated.

As explained above, with the game device of the present invention and according to an instruction from the user, the appearance of the character can be made to be a suitable appearance based on an image taken by a camera. In other words, the user of the game device of the present invention can set the texture to be applied to a character in virtual space while referencing the performance of the generated texture. The user uses a camera to take an image that will be the basis for the color and pattern of the texture to be applied to the clothing of the character, and by having the game device process the image that was taken, texture that will be applied to the clothing of the character is generated.

Moreover, the game device of the present invention can comprise a score determiner that determines the game score based on the performance parameter that was found for the confirmed texture.

The game score is typically points, but is not limited to that. In other words, the game score can be the status of procuring items, the character's status, the movable range of the character and the like.

For example, in an action game wherein a character infiltrates an enemy stronghold, the game score can be considered to be whether or not the character is discovered by the enemy, or the game score can be considered to be the character's life or death, or the state of injury, or the game score can be considered to be the rate of accomplishment of a mission.

Moreover, in a game wherein a character dances or sings on a stage, for example, the game score can be considered to be passing or failing an audition where being fashionable is taken into consideration, or the game score can be considered to be individual evaluation that is given according to the degree of being fashionable.

As was explained above, with the game device of the present invention, the character's appearance, which is the material used when determining the game score, can be taken to be an appropriate appearance that is based on an image taken by a camera.

The game device of the present invention may also comprise an imaging instruction receiver and an imager.

The imaging instruction receiver receives an imaging instruction from the user. The imaging instruction, for example, is an operation of pressing a button of the game device. In other words, an imaging instruction is performed when first generating a texture candidate, or when not satisfied with the performance parameter that was presented by the performance parameter presenter. On the other hand, the user performs a confirmation instruction when satisfied with the performance parameter that was presented by the performance parameter presenter.

The imager takes an image according to the received imaging instruction. In other words, the imager generates an image that expresses the state of the imaging range according to the imaging instruction. On the other hand, in order that a desired image is obtained, the user performs an imaging instruction after adjusting the position and angle of the imager.

An image acquirer acquires the image that was taken.

As explained above, with the game device of the present invention, the appearance of the character may be taken to be an appropriate appearance that is based on an image that is taken by the imager of the game device.

In the game device of the present invention, the performance parameter acquirer can find the performance parameter based on the similarity and the level of mosaic processing. For example, the performance parameter becomes higher, the higher the level of mosaic processing is, and the performance parameter becomes lower, the lower the level of mosaic processing is. With this kind of construction, the level of mosaic processing is low, so that it is possible to suppress generation of texture having an unsuitable pattern. As described above, an unsuitable pattern, for example, is a pattern with too much contrast, or a pattern that includes unsuitable characters (for example, characters that express proper nouns, or characters that express obscene words).

As explained above, with the game device of the present invention, it is expected that the user will set an appropriate appearance as the character appearance.

In the game device of the present invention, the level of mosaic processing may be set based on the difference in clarity of the acquired image and the generated image. How clarity is defined can be appropriately adjusted. For example, clarity can be defined as the average value of the difference between each of the brightness values of all of the pixels of an image, and the average value of the brightness values of all of the images of the image.

As explained above, with the game device of the present invention, the performance parameter is found according to the appropriately found level of mosaic processing, and it is expected that the user will set an appropriate appearance as the character appearance.

The game device of the present invention may further comprise a level specification receiver that receives a specification from the user for the level of the mosaic processing. In this case, the candidate generator generates an image for which mosaic processing has been performed on the acquired image according to the received level specification.

The level of mosaic processing, for example, is the coarseness of the mosaic. The level of mosaic processing is higher the coarser the mosaic is, and the level of mosaic processing is lower the finer the mosaic is. The coarseness of the mosaic, for example, is specified by the size of one small area (n dots×m dots) for which the brightness values have been averaged by mosaic processing. The mosaic coarseness can be selected by the user from a plurality of preset size candidates, or the size can be specified directly by the user.

The candidate generator applies mosaic processing to the acquired image in order to create the requested degree of coarseness. More specifically, the candidate generator first divides the acquired image into small areas having the requested degree of coarseness. Then, for each of the small areas, the candidate generator assigns a brightness values for the all of the pixels included in each small area based on the average brightness value of all of the pixels included in that small area.

As explained above, with the game device of this present invention, mosaic processing is performed on an acquired image at a requested level, and it is expected that the user will set an appropriate appearance as the character appearance.

Moreover, the game device of the present invention may further comprise a receiver that receives the texture candidate and performance parameter that was found for that texture candidate from another game device by ad hoc communication or infrastructure communication. In this case, the performance parameter presenter presents the received performance parameter to the user. Also, the texture confirmer, when a confirmation instruction is received, confirms the received texture candidate as the texture to be applied to the clothing of the character.

In other words, the candidate for the texture to be applied to the clothing of the character may be received from another game device. In this case, the receiver receives the texture candidate and the performance parameter that was found for that texture candidate. The other game device, for example, is a game device that comprises the same construction as the game device of the present invention. Here, in the case of ad hoc communication, the game device is directly connected with the other game device without going through an access point. On the other hand, in the case of infrastructure communication, the game device is connected with the other game device via an access point.

Here, the performance parameter presenter presents the user with the received performance parameter instead of the performance parameter that was acquired by the performance parameter acquirer. The user references the presented performance parameter, and determines whether or not to use that texture candidate as the texture to be applied to the clothing of the character. When the user determines to use that texture candidate, the user performs a confirmation instruction as described above. When the confirmation instruction is received, the texture confirmer confirms the texture candidate that was received as the texture to be applied to the clothing of the character instead of the texture candidate that was generated by the candidate generator.

As explained above, with the game device of the present invention, a texture candidate is received from another game device, and it is expected that the user will set an appropriate appearance as the character appearance.

Moreover, in the game device of the present invention, a texture candidate that may be received by the receiver may be limited to a texture candidate whose performance parameter that was found for that texture candidate is higher than a specified threshold value. In other words, reception of the texture candidate is only allowed when it is expected that the performance parameter will be comparatively high, and the probability that the character will be discovered is low. With this construction, it is possible to suppress reception of a texture candidate for which the probability that the character will be discovered by the enemy is high, and that will not be a useful texture candidate.

When the performance parameter acquirer is constructed so that the performance parameter is higher, the higher the level of mosaic processing is, reception of a texture candidate is only allowed when the level of mosaic processing is comparatively high. With this construction, it is expected that a texture candidate that can be given to another user will be set and generated to have a high level of mosaic processing. Therefore, it is considered possible to suppress the exchange of texture candidates among users in which patterns that express unsuitable characters are included.

As explained above, with the game device of the present invention, texture candidates that are expected to be used are received, and it is expected that the user will set an appropriate appearance as the character appearance.

In the game device of the present invention, the specified threshold value may be set to be higher when the receiver receives the texture candidate by infrastructure communication compared to when the receiver receives the texture candidate by ad hoc communication. This is because it is considered that in distinguishing the acceptance threshold value for the performance parameter by the infrastructure communication and ad hoc communication in this way, the probability that the communicating person can be trusted differs according to whether communication is infrastructure communication or ad hoc communication.

In other words, a communicating party that is communicating by ad hoc communication is typically an acquaintance and is a person who can be trusted. Therefore, in ad hoc communication, it is considered that the possibility of receiving a texture candidate of which performance parameter is low and which is not useful is low. On the other hand, a communicating party that is communicating by infrastructure communication is not limited to an acquaintance, and is not limited to someone who is trusted. Therefore, in infrastructure communication, it is considered that the possibility of receiving a texture candidate of which performance parameter is low and which is not useful is high.

With this construction, it is expected that a texture candidate that can be given to another user will be set and generated with a high level of mosaic processing. Therefore, it is considered possible to suppress the exchange among users' texture candidates that include patterns that express unsuitable characters.

When the performance parameter acquirer is constructed so that the higher the level of mosaic processing is the performance parameter becomes higher, a texture candidate that can be received by infrastructure communication is limited to a texture candidate that has a comparatively high level of mosaic processing. Therefore, in infrastructure communication, for example, it is not possible to receive a texture candidate having a pattern that clearly expresses unsuitable characters. On the other hand, in ad hoc communication, it is even possible to receive texture candidates that express unsuitable characters, which could not be received by infrastructure communication.

As explained above, with the game device of the present invention a suitable texture candidate is received, and it is expected that the user will set an appropriate appearance as the character appearance.

Furthermore, in the game device of the present invention, the receiver further receives information that identifies the user of the game device that is the source that sends the texture candidate. In this case, the specified acceptance threshold value is set higher when the user that is indicated by the received information is not a preset user than when the user that is indicated by the received information is a preset user.

The received information may be any kind of information, such as a user name, user ID, user nickname or the like, for example, as long as the information can identify the user of the game device that is the sending source. Whether or not a user indicated by the received information is a preset user can be determined, for example, by whether or not the received information matches information that is stored in advance in a memory.

Here, when the communicating party is a preset user, it is considered that the communicating party is a person who can be trusted. Therefore, in that case, it is considered that the possibility of receiving a texture candidate that will not be useful, or a texture candidate that includes unsuitable characters is comparatively low. On the other hand, when the communicating party is not a preset user, the communicating party may not be a person who can be trusted. Therefore, in that case, it is considered that the possibility of receiving a texture candidate that will not be useful, or a texture candidate that includes unsuitable characters is comparatively high. For this reason, when the communicating party is not a preset user, the specified acceptance threshold value is set higher in order to suppress the reception of a texture candidate that is not very useful, or a texture candidate that includes unsuitable characters.

As explained above, with the game device of the present invention, a suitable texture candidate is received, and it is expected that the user will set an appropriate appearance as the character appearance.

In order to accomplish the object above, a game control method of another aspect of the present invention is a game control method that is executed by a game device comprising an image acquirer, a candidate generator, a color acquirer, a performance parameter acquirer, a performance parameter presenter, a confirmation instruction receiver, and a texture confirmer, and comprises: an image acquisition step, a candidate generation step, a color acquisition step, a performance parameter acquisition step, a performance parameter presentation step, a confirmation instruction receiving step and a texture confirmation step.

First, in the image acquisition step, the image acquirer acquires an image taken by a camera. The image that is acquired may be an image that is taken by an internal camera inside the game device, or may be an image that is taken by an external camera. An image that expresses background including surroundings such as a forest, field, river, city and the like may be used as the image that is acquired.

In the candidate generation step, the candidate generator generates an image for which mosaic processing has been performed on the acquired image, and designates the generated image as a candidate for texture to be applied to a character in virtual space. The character is typically the main character in virtual space that is operated by the user. Here, the texture that is applied to the clothing of the character, for example, is used for camouflaged clothes that are worn by the character. In other words, the candidate generator designates the color or pattern that was obtained by performing mosaic processing to the acquired image as a color or pattern candidate for camouflaged clothes to be worn by the character.

Next, in the color acquisition step, the color acquirer acquires a color that symbolizes the generated texture candidate. The color that symbolizes the texture candidate, for example, when considering the texture as one image, can be defined as in (A) to (C) below.

(A) Color of a preset pixel (for example, the pixel in the center, or a pixel in one of the four corners).

(B) Color of a randomly set pixel (for example, the pixel at coordinates corresponding to numbers that were generated by a random number generator).

(C) Intermediate color between the colors of a plurality of pixels such as preset pixels or randomly set pixels. (For example, a color represented by the average value of the brightness value of the pixel in the center and brightness value of the pixels in the four corners. The average value can be a simple average, or may be a weighted average.)

Moreover, the color that symbolizes the texture candidate may be one (one color), or may be more than one (plurality of colors).

In the performance parameter acquisition step, the performance parameter acquirer finds a performance parameter for the texture candidate from the similarity between the acquired color and a color that symbolizes a point of interest in the virtual space. The point of interest, for example, can be a point in virtual space in the direction the character is going (a point further in the back of the screen than the character). In that case, the color that symbolizes the point of interest, for example, can be the color of an object (an object that is located further in the back of the screen than the character) in virtual space that is in the direction of advancement of the character. In the embodiments, the color that symbolizes the point of interest is correlated with the topography of the point of interest and is set beforehand.

Here, the performance parameter for the texture candidate is found from the similarity. For example, the performance parameter is found so that the higher the similarity is, the higher the performance parameter becomes. However, elements other than the similarity may also be considered when finding the performance parameter.

Next, in the performance parameter presentation step, the performance parameter presenter presents the performance parameter that was found to the user. The method for presenting the performance parameter to the user is arbitrary. For example, a character string that expresses the performance parameter may be displayed on the screen, or sound that expresses the performance parameter may be outputted from a speaker. From this presentation, the user is able to know the performance parameter of the current texture candidate.

In the confirmation instruction receiving step, the confirmation instruction receiver receives a confirmation instruction from the user. The confirmation instruction that is received from the user, for example, is the operation of pushing buttons of the game device. When the user is satisfied with the presented performance parameter, a confirmation instruction is performed, and when the user is not satisfied with the presented performance parameter, a confirmation instruction is not performed.

Here, in the texture confirmation step, when a confirmation instruction is received, the texture confirmer confirms the texture candidate as the texture to be applied to the clothing of the character. When a confirmation instruction is not received, the next image is acquired, and the next texture candidate is generated.

As explained above, with the game control method of the present invention and according to an instruction from the user, the appearance of the character can be made to be a suitable appearance based on an image taken by a camera. In other words, the user of the game device that is controlled by the game control method of the present invention can set the texture to be applied to a character in virtual space while referencing the performance of the generated texture. The user uses a camera to take an image that will be the basis for the color and pattern of the texture to be applied to the clothing of the character, and by having the game device process the image that was taken, texture that will be applied to the clothing of the character is generated.

The non-transitory information recording medium on which a computer readable program is recorded of another aspect of the present invention causes a computer to function as each of the elements of the game device described above, or causes a computer to execute each of the steps of the game control method described above.

The program of the present invention can be recorded on a computer readable information recording medium such as a compact disk, a flexible disk, a hard disk, a magneto-optical disk, a digital video disk, magnetic tape, a semiconductor memory or the like. The program can be distributed and sold independent from the computer that executes the program via a computer communication network. Moreover, the information recording medium can be distributed and sold independent of the computer.

With the present invention it is possible to provide a game device, which allows the appearance of a character in virtual space to be that of an image taken by a camera, a game control method, and a non-transitory information recording medium on which is recorded a computer readable program that makes the game device and game control method possible by way of a computer.

### BRIEF DESCRIPTION OF THE DRAWINGS

A more complete understanding of this application can be obtained when the following detailed description is considered in conjunction with the following drawings, in which;

FIG. 1 is a schematic diagram illustrating the construction of a typical information processing device that achieves the game device of a first embodiment of the present invention;

FIG. 2A is a first schematic diagram that illustrates the external appearance of a game device of a first embodiment of the present invention;

FIG. 2B is a second schematic diagram that illustrates the external appearance of a game device of a first embodiment of the present invention;

FIG. 3 is a block diagram of the construction of a game device of a first embodiment of the present invention;

FIG. 4A is a diagram illustrating an image taken by a camera;

FIG. 4B is a diagram illustrating an image that was extracted from an image taken by a camera;

FIG. 5A is a diagram illustrating an image for which detailed mosaic processing was performed;

FIG. 5B is a diagram illustrating an image for which coarse mosaic processing was performed;

FIG. 6A is a diagram illustrating an area where brightness values are referenced for finding a candidate symbol color 1;

FIG. 6B is a diagram illustrating an area where brightness values are referenced for finding a candidate symbol color 2;

FIG. 7A is a diagram illustrating brightness values that are referenced for finding a candidate symbol color 1;

FIG. 7B is a diagram illustrating brightness values that are referenced for finding a candidate symbol color 2;

FIG. 7C is a diagram illustrating brightness values for candidate symbol color 1 and brightness values for candidate symbol color 2;

FIG. 7D is a diagram illustrating brightness values for point symbol color 1 and brightness values for point symbol color 2;

FIG. 8A is a diagram illustrating the relationship between the difference in brightness and individual similarity;

FIG. 8B is a diagram that illustrates the individual similarity for each combination of candidate symbol color and point symbol color;

FIG. 8C is a diagram illustrating the relationship between the individual similarity and the overall similarity;

FIG. 9 is a diagram illustrating the relationship between the overall similarity and performance parameters;

FIG. 10 is a flowchart illustrating the game control process that is executed by the game device of a first embodiment of the present invention;

FIG. 11 is a flowchart illustrating a texture confirmation process.

FIG. 12 is a diagram illustrating a screen that provides the performance parameter;

FIG. 13 is a diagram illustrating the state when texture has been applied to a character;

FIG. 14A is a diagram illustrating a game system in which infrastructure communication is achieved;

FIG. 14B is a diagram illustrating a game system in which ad hoc communication is achieved;

FIG. 15 is a block diagram illustrating the construction of a game device of a second embodiment of the present invention;

FIG. 16 is a flowchart illustrating the texture confirmation process that is executed by the game device of a second embodiment of the present invention;

FIG. 17A is a diagram illustrating the state in which the brightness value for point symbol color 1 and the brightness value for point symbol color 2 are correlated for each background;

FIG. 17B is a diagram illustrating the individual similarity for each combination of candidate symbol color and point symbol color for each background; and

FIG. 17C is a diagram illustrating the relationship between the individual similarity and the overall similarity.

### DETAILED DESCRIPTION

In the following, embodiments of the present invention will be explained. In order to make the explanation easy to understand, embodiments in which the present invention is applied to a game device will be explained. However, the present invention could similarly be applied to an information processing device such as a mobile telephone. In other words, the embodiments explained below are for the purpose of explanation, and do not limit the scope of the present invention. Embodiments in which some or all of these elements are replaced with equivalent elements by one skilled in the art can also be employed. Therefore, such embodiments are included within the scope of the present invention.

### Embodiment 1

### Explanation of an Information Processing Device

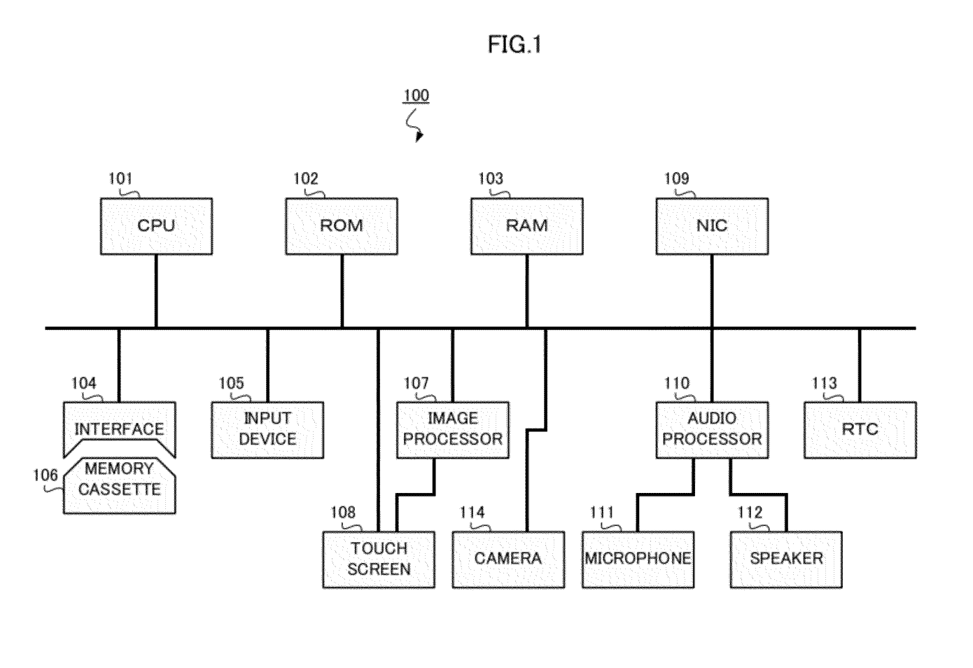

FIG. 1 is a schematic diagram illustrating the construction of a typical information processing device 100 that achieves the information display device of a first embodiment of the present invention.

The information processing device 100 comprises a CPU (Central Processing Unit) 101, ROM (Read Only Memory) 102, RAM (Random Access Memory) 103, an interface 104, an input device 105, a memory cassette 106, an image processor 107, a touch screen 108, an NIC (Network Interface Card) 109, an audio processor 110, a microphone 111, a speaker 112, an RTC (Real Time Clock) 113 and a camera 114.

When the power to the information processing device 100 is turned ON with the memory cassette 106 (described in detail later), on which a program and data for game control, mounted in a slot (not illustrated in the figure) that is connected to the interface 104, the program for game control is executed. As a result, the game device of this embodiment is achieved. The game device of this embodiment is a game device that controls an action game in virtual space wherein a main character performs espionage activities while undercover wearing camouflaged clothes.

The CPU 101 controls the overall operations of the information processing device 100. The CPU 101 is connected to each of the component elements, and exchanges control signals and data. The CPU 101 acquires various kinds of data from the component elements. The CPU 101 processes the various kinds of data by performing various calculations. The CPU 101 supplies data and control signals that indicate the processing results to the various component elements. The CPU 101 comprises an internal cache and registers. The various kinds of data that are acquired by the CPU 101 are temporarily stored in the cache. After that, that data are fetched by the registers and various operations are performed.

The IPL (Initial Program Loader) that is executed immediately after the power is turned ON is stored in ROM 102. By executing the IPL, the program that is stored on the memory cassette 106 is read into RAM 103, and the CPU 101 starts executing the program. The operating system program and data necessary for overall control of the operation of the information processing device 100 are stored in ROM 102.

The RAM 103 temporarily stores data and programs. The program and data read from the memory cassette 106 are stored in RAM 103. In addition, RAM 103 temporarily stores information to be transmitted to external devices, and information that was transmitted from external devices.

The interface 104 is an interface for connecting the memory cassette 106 to the information processing device 100.

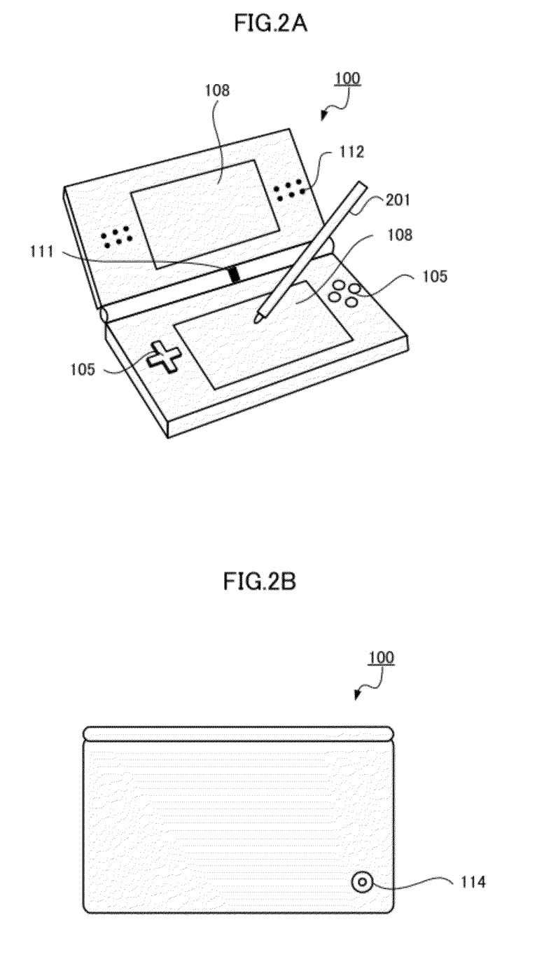

The input device 105 comprises control buttons as illustrated in FIG. 2A, and receives instruction input from the user. The input device 105 comprises direction buttons for specifying Up, Right, Down and Left, and a set button.

The memory cassette 106 is connected to the information processing device 100 via the interface 104 such that it can be freely connected or disconnected. The memory cassette 106 comprises a read only ROM area and an SRAM (Static random-access memory) area. The read only ROM area is an area where a word processor program, and image data and audio data that will be used by that program are stored. The SRAM area is an area where data, such as images taken by a camera, is saved. The CPU 101 performs a reading process on the memory cassette 106, reads the necessary program and data, and temporarily stores the read data in RAM 103.

The image processor 107 process data that is read from the memory cassette 106. The image processor 107 comprises an image calculation processor (not illustrated in the figures) and a frame memory (not illustrated in the figures). Processing is executed by the image calculation processor. The processed data (image information) is stored in the frame memory (not illustrated in the figures). The image information that is stored in the frame memory is converted to a video signal at specified synchronization timing. The image information that is converted to a video signal is output to a touch sensor type display (touch screen 108). As a result, various image displays are possible.

The image calculation processor executes high-speed operations such as overlaying 2-dimensional images, transparency operations such as cc blending, and various saturation operations. Moreover, the image calculation processor can also perform high-speed execution of operations for obtaining rendered images. Rendered images are images that express a state from a specified viewpoint position looking down on polygons that are arranged in 3-dimensional virtual space. Rendered images are generated by performing rendering of polygon information using the Z-buffer method. Polygon information is information that expresses polygons that are arranged in 3-dimensional virtual space and to which various kinds of texture are added. The image calculation processor comprises a function of totaling the degree of light shining on a polygon by a typical (positive) light source such as a point light source, a parallel light source, conical light source or the like. These functions are implemented by a library or the hardware. As a result, these calculations can be performed at high speed.

Furthermore, the image calculation processor draws character strings as 2-dimensional data into the frame memory according to font information that defines character shapes, and draws polygon surfaces. The image calculation processor can use typical font information that is stored in ROM 102 or can use special font information that is stored on the memory cassette 106. The image calculation processor, working together with the CPU 101, executes the various processes described above.

The touch screen 108 is a liquid-crystal panel that comprises overlapping touch sensors. The touch-screen 108 detects position information that corresponds to a position that is pressed by the user's finger or a touch pen, and inputs that information to the CPU 101. In other words, the touch screen 108, similar to the input device 105, receives instruction input from the user. The touch screen 108, for example, as illustrated in FIG. 2A, is located in the center section of the front surface of the information processing device 100.

It is possible, according to an instruction that is inputted by the user from the input device 105 or the touch panel 108, to store data that was temporarily stored in RAM 103 on an appropriate memory cassette 106.

The NIC 109 is for connecting the information processing device 100 to a computer communication network (not illustrated in the figure) such as the Internet. The NIC 109, for example, comprises an interface (not illustrated in the figure) that complies with the 10BASE-T/100BASE-T standard that is used when creating an LAN (Local Area Network). Alternatively, the NIC 109 comprises an interface (not illustrated in the figure) that functions as an intermediary between the CPU 101 and an analog modem, ISDN (Integrated Services Digital Network) modem, ADSL (Asymmetric Digital Subscriber Line) modem for connecting to the Internet using a telephone line, a cable modem for connecting to the Internet using a cable television line, and the like.

The information processing device 100 can be connected to an SNTP server on the Internet via the NIC 109, and by acquiring information from the SNTP server, can obtain current date and time information.

The audio processor 110 converts audio data that was read from the memory cassette 106 to an analog audio signal. The audio processor 110 supplies the analog audio signal to the speaker 112 that is connected to the audio processor 110, and sound is outputted from the speaker 112 based on that analog audio signal. The audio processing 110, according to control from the CPU 101, creates sound effects that are to be generated while the game is being played, and sound that corresponds to those sound effects is output from the speaker 112.

When the audio data that is stored on the memory cassette 106 is MIDI data, the audio processor 110 references the audio source data of that MIDI data, and converts the MIDI data to PCM data. When the audio data that is stored on the memory cassette 106 is compressed audio data in the ADPCM (Adaptive Differential Pulse Code Modulation) format or Ogg Vorbis format, the audio processor 110 expands the data and converts the data to PCM data. The PCM data undergoes D/A (Digital/Analog) conversion at timing that corresponds to the sampling frequency, and by outputting that data to the speaker 112, sound can be outputted.

The audio processor 110 performs A/D (Analog/Digital) conversion of an analog signal that is inputted from the microphone 111 at an appropriate sampling frequency, and generates a digital signal in PCM format.

The microphone 111 converts sound into an analog signal, and supplies the analog signal that was obtained from conversion to the audio processor 110. The microphone 111, for example, as illustrated in FIG. 2A, is located on the end section of the front surface of the information processing device 100.

The speaker 112 converts the analog signal that was supplied from the audio processor 110 to sound, and outputs that sound. The speaker 112, for example, as illustrated in FIG. 2A, is located on the end section on the front surface of the information processing device 100.

The RTC 113 is a device for a clock that comprises a quartz oscillator, oscillation circuit and the like. The RTC 113 receives power from an internal battery, and even when the power to the information processing device 100 is turned OFF, the RTC 113 continues to operate.

The camera 114 takes an image of a specified area, and generates an image. The camera 114, for example, as illustrated in FIG. 2B, is located on the end section on the rear surface of the information processing device 100.

In addition, the information processing device 100 can comprise a DVD-ROM drive that can read programs and data from a DVD-ROM instead of the memory cassette 106, with the DVD-ROM having the same kind of function as the memory cassette 106. Moreover, the interface 104 can be such that data is read from an external memory medium other than the memory cassette 106. Alternatively, the information processing device 100 can use a large-capacity external memory such as a hard drive to serve the same function as ROM 102, RAM 103, the memory cassette 106 and/or the like.

### Explanation of the Game Device

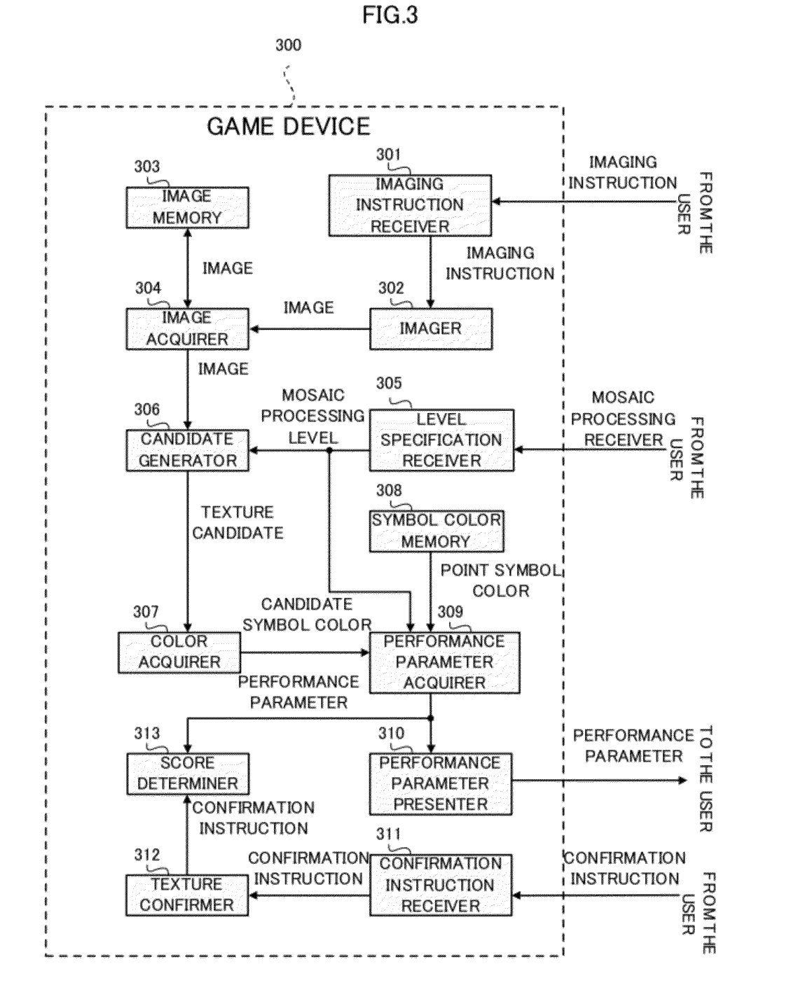

Next, the function of the game device 300 of the embodiment will be explained with reference to the drawings. First, the construction of the game device of this embodiment of the present invention will be explained with reference to FIG. 3. When the power to the information processing device 100 is turned ON with the memory cassette 106 mounted in the interface 104, the information display device 300 of the embodiments is created.

As illustrated in FIG. 3, the game device 300 comprises an imaging instruction receiver 301, an imager 302, an image memory 303, an image acquirer 304, a level specification receiver 305, a candidate generator 306, a color acquirer 307, a symbol color memory 308, a performance parameter acquirer 309, a performance parameter presenter 310, a confirmation instruction receiver 311, a texture confirmer 312 and a score determiner 313.

The imaging instruction receiver 301 receives an imaging instruction from the user. The imaging instruction receiver 301, for example, comprises the input device 105 and the touch screen 108.

The imager 302 takes images according to the received imaging instruction. The imager 302, for example comprises the camera 114.

The image memory 303 stores images that were taken by the camera 114. The images that are stored in the image memory can be images that are taken by the imager 302, or images that are supplied from an external information processing device. The image memory 303, for example, comprises the memory cassette 106.

Image acquirer 304 acquires images taken by the camera. The images that the image acquirer 304 acquires can be images that are supplied from the imager 302, or images that are stored in the image memory 303. The image acquirer 304, for example, comprises the CPU 101.

The level specification receiver 305 receives instructions from the user regarding the level of the mosaic process. The level of the mosaic process, for example, is 8 pixels×8 pixels, or 16 pixels×16 pixels, and specifies the size of the area where the brightness value will be averaged by the mosaic process. The level specification receiver 305, for example, comprises the input device 105 and touch screen 108.

The candidate generator 306 generates an image for which mosaic processing has been performed for the acquired image, and designates the generated image as a candidate for texture to be applied to a character in virtual space. The mosaic process is executed according to the level of the mosaic process that was received by the level specification receiver 305. Moreover, the candidate generator 306 can trim an image, rotate an image, join images and the like when generating a texture candidate from an acquired image.

The texture that is applied to a character expresses the camouflaged clothes and accessories worn by the character (hereinafter referred to as “camouflaged clothes”). Clothes and accessories include clothes, pants, hats, gloves, socks, helmets, belts, shoes and the like. The candidate generator 306, for example, comprises the CPU 101 and image processor 107.

The color acquirer 307 acquires the color that symbolizes the generated texture candidate (hereafter referred to as the “candidate symbol color”). The color acquirer 307, for example, extracts a plurality of pixels from an image that expresses texture (image for which mosaic processing has been performed), and designates the color having the average value of the brightness values of the extracted plurality of pixels as the brightness value as the candidate symbol color. The candidate symbol color can be one (one color), or two or more (two colors or more). In this embodiment, the case of extracting two colors, a candidate symbol color 1, and a candidate symbol color 2, will be explained. The color acquirer 307, for example, comprises the CPU 101.

The symbol color memory 308 stores the color that symbolizes a point in virtual space that is of interest (hereafter, appropriately referred to as the “point symbol color”). The point of interest in virtual space, for example, is a specified point in the stage that the character is trying to challenge. The point symbol color can be one color, or two or more colors. In this embodiment, the case of storing two colors, point symbol color 1 and point symbol color 2, will be explained. The symbol color memory 308, for example, comprises the memory cassette 106.

The performance parameter acquirer 309 finds performance parameters of texture candidates from the similarity of candidate symbol colors and point symbol colors. This similarity, for example, is found for each combination of candidate symbol color and point symbol color, and is found from the difference between the brightness value of a candidate symbol color and the brightness value of a point symbol color. Moreover, in addition to similarity, performance parameters can be appropriately found based on the level of mosaic processing. The performance parameter acquirer 309, for example, comprises the CPU 101.

The performance parameter presenter 310 presents the performance parameter found to the user. On the other hand, the user checks the presented performance parameter, and determines whether or not to use the texture candidate as the texture applied to the clothing of the character. The method of presenting performance parameters is arbitrary. For example, the performance parameter presenter 310 can display the performance parameter on the screen as an identifiable numerical value, character string or image, or can output the performance parameter as an identifiable sound. The performance parameter presenter 310, for example, can comprise the CPU 101, image processor 107 and touch screen 108, or can comprise the CPU 101, the audio processor 110 and speaker 112.

The confirmation instruction receiver 311 receives a confirmation instruction from the user. In other words, when the user determines to use a texture candidate as the texture to be applied to the clothing of the character, the user inputs a confirmation instruction. The confirmation instruction receiver 311, for example, comprises the input device 105 or touch screen 108.

After receiving a confirmation instruction, the texture confirmer 312 confirms the texture candidate as the texture to be applied to the clothing of the character. The texture confirmer 312, for example, comprises the CPU 101.

The score determiner 313 determines the game score based on the performance parameter for the confirmed texture. In this embodiment, the score determiner 313 sets the probability that the enemy will discover the character according to the performance of the camouflaged clothes worn by the character. The probability of being discovered by the enemy is an element that directly or indirectly has an effect on the game score. Typically, when the character is discovered by the enemy the score becomes bad, and when the character is not discovered by the enemy, the score becomes good. The score determiner 313, for example, comprises the CPU 101.

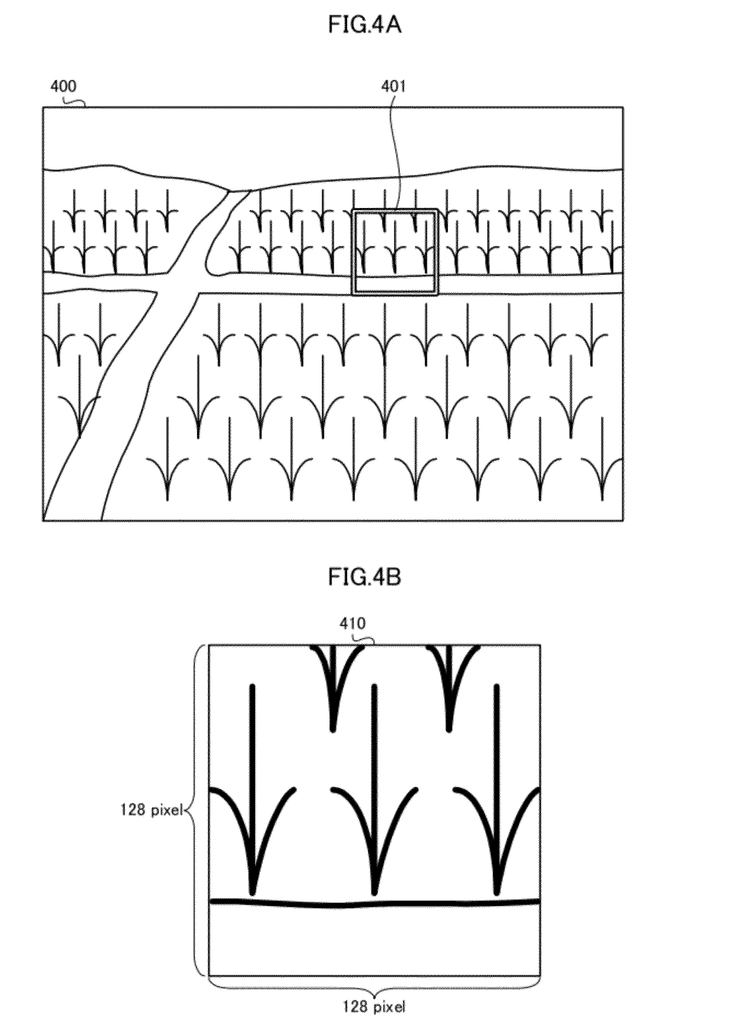

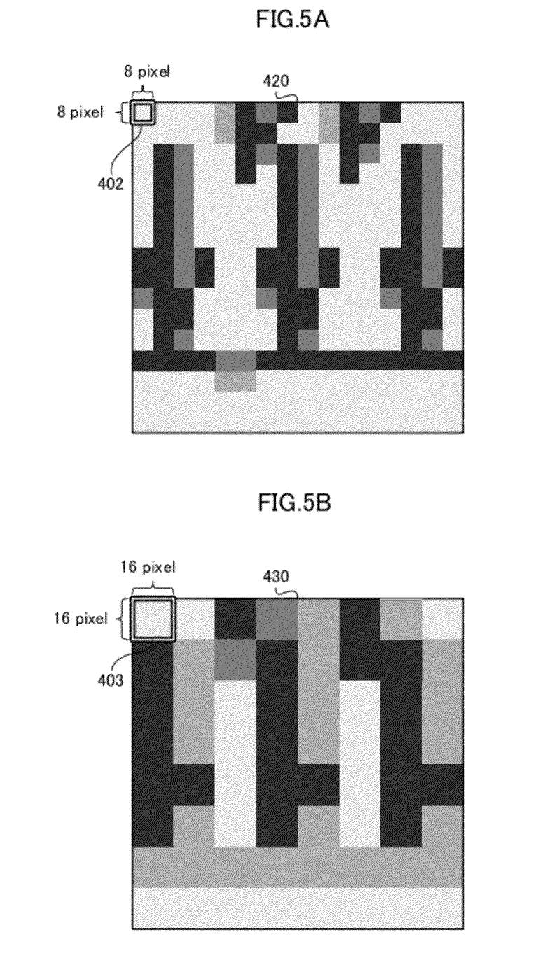

Next, the method of generating a texture candidate from an image that was taken and obtained will be explained with reference to FIGS. 4A and 4B and FIGS. 5A and 5B.

FIG. 4A illustrates an image 400 that was taken by the camera 114. The image 400 is an image that was taken of a rice field. FIG. 4B illustrates an image 410 having a specified size (128 pixels x 128 pixels) that was extracted from the image 400. The CPU 101 can extract an image of a predetermined area from the image 400 as the image 410, or as will be described below, can extract an image specified by the user from the image 400 as the image 410.

First, the CPU 101 displays the overlapping image 400 and image 401 on the touch screen 108. The image 401 is an image that expresses a frame surrounding a specified area of the image 400. Here, the CPU 101 moves the image 401 in a range overlapping the image 400 according to a movement operation that is performed using the input device 105 or touch screen 108. Then, the CPU 101 confirms the image of the area of the image 400 that is surrounded by the image 401 as the image 410 according to a confirmation operation that is performed using the input device 105 or touch screen 108.

Next, the CPU 101 performs mosaic processing at a level specified by the user. The mosaic level, for example, is specified according to the size of the area where the brightness values are averaged by mosaic processing (hereafter, this is appropriately referred to as the “mosaic coarseness” or the “mosaic size”). When the mosaic coarseness is 8 pixels×8 pixels, the image 410 that is 128 pixels×128 pixels is divided into 256 blocks (16 blocks×16 blocks).

Here, the brightness values for all of the pixels included in one block are averaged for each of the three color components (R (Red), G (Green), B (Blue)). In other words, the brightness value of the R component of all of the pixels included in one block is taken to be the average value of the brightness value of the R component of all of the pixels included in that one block. Similarly, the brightness value of the G component of all of the pixels included in one block is taken to be the average value of the brightness value of the G component of all of the pixels included in that one block. The brightness value of the B component of all of the pixels included in one block is taken to be the average value of the brightness value of the B component of all of the pixels included in that one block.

FIG. 5A illustrates an image 420 after mosaic processing has been performed for the case when the mosaic coarseness is 8 pixels×8 pixels surrounded by the frame 402. On the other hand, FIG. 5B illustrates an image 430 after mosaic processing has been performed for the case when the mosaic coarseness is 16 pixels×16 pixels surrounded by the frame 403. Image 420 and image 430 are taken to be candidates for the texture to be applied to the clothing of the character.

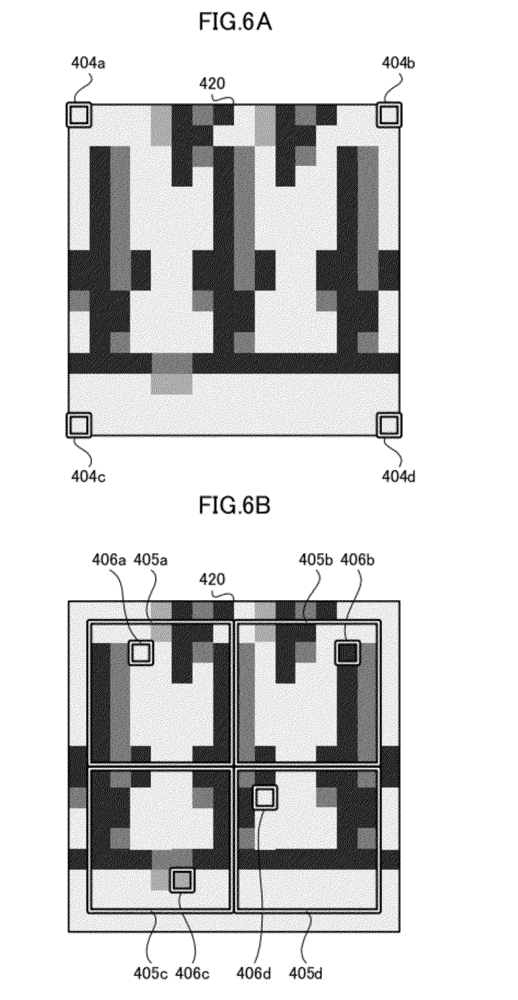

Next, the method for finding the performance parameters of the texture candidates will be explained with reference to FIG. 6A to FIG. 9.

First, the CPU 101 acquires one or more candidate symbol color that symbolizes the image 420 that expresses a texture candidate. It is possible to appropriately adjust how the candidate symbol color is defined, and it is also possible to appropriately adjust the number of candidate symbol colors. In this embodiment, there are two candidate symbol colors, and of the two candidate symbol colors, one is taken to be candidate symbol color 1, and the other of the two candidate symbol colors is taken to be candidate symbol color 2.

In this embodiment, the candidate symbol color 1 is the average color of the colors of the four corner blocks of image 420. That is, in this embodiment, candidate symbol color 1 can be considered to be the color that symbolizes the color of the end sections of the image 420. The average color is the color where the brightness value of each component is the average value of the brightness values of that component for two or more colors. In other words, the average color is the average value of the brightness values for each component color.

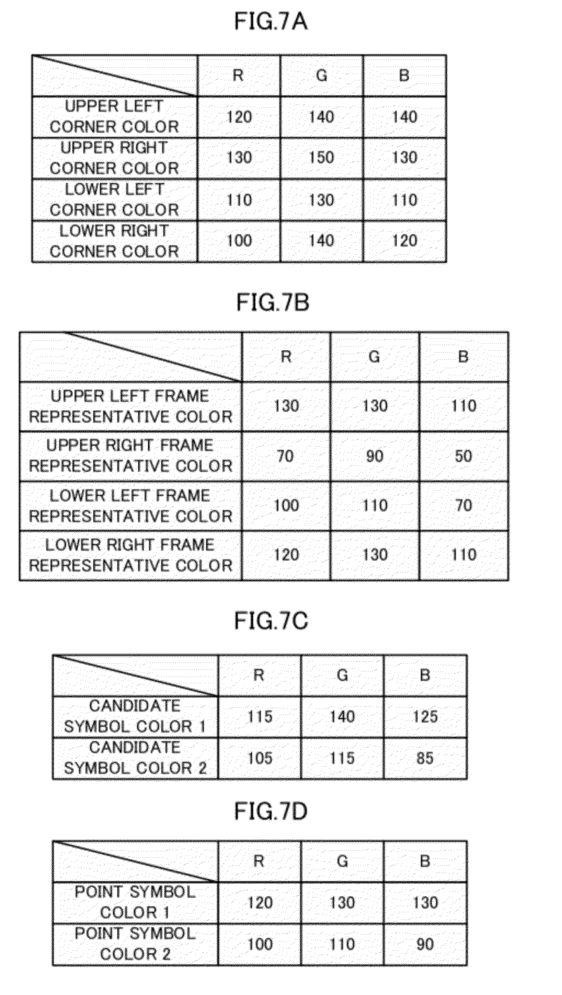

FIG. 6A illustrates an example where the average color of the color upper left corner block indicated by frame 404a, the color of the upper right block indicated by frame 404b, the color of the lower left block indicated by frame 404c, and the color of the lower right block indicated by frame 404d is taken to be the candidate symbol color 1. Moreover, FIG. 7B illustrates the brightness values of each of the colors of the four corner blocks, and FIG. 7C illustrates the brightness values for the candidate symbol color 1.

On the other hand, the candidate symbol color 2 is the average color of four blocks of color that are extracted one at a time from four set areas in the image 420 (hereafter, appropriately referred to as “representative color”). In other words, in this embodiment, candidate symbol color 2 can be considered to be the color symbolizing the color in the center section of the image 420. It is possible to appropriately adjust which blocks to extract from the four areas. For example, all of the blocks included in each area can be correlated with a numerical value, and the blocks corresponding to random numbers that are generated by a random number generated can be extracted.

FIG. 6B illustrates an example in which the average color of the color of the block indicated by the frame 406a that is extracted from the area indicated by the frame 405a (representative color of the upper left frame), the color of the block indicated by the frame 406b that is extracted from the area indicated by the frame 405b (representative color of the upper right frame), the color of the block indicated by the frame 406c that is extracted from the area indicated by the frame 405c (representative color of the lower left frame) and the color of the block indicated by the frame 406d that is extracted from the area indicated by the frame 405d (representative color of the lower right frame) is taken to be candidate symbol color 2. Moreover, FIG. 7B illustrates the brightness values of each of the four representative colors, and the FIG. 7C illustrates the brightness values of candidate symbol color 2.

Here, the point symbol color will be explained in comparison with the candidate symbol color. The point symbol color is a color that symbolizes a point of interest in virtual space. In one embodiment, the point symbol color is appropriately adjustably defined and/or, the number of point symbol colors is appropriately adjustable. In an example embodiment, there are two point symbol colors, with one of the two point symbol colors taken to be point symbol color 1, and the other of the two point symbol colors taken to be point symbol color 2.

The point symbol color 1 and point symbol color 2, for example, are colors that are extracted from textures that are applied to objects at points of interest in virtual space (typically, background object when the character is located at a point of interest). Point symbol color 1 and point symbol color 2 are presumed to be stored beforehand on a memory cassette 106 or the like. FIG. 7D illustrates the brightness values for point symbol color 1 and the brightness values for point symbol color 2.

Next, the method for finding the similarity between the candidate symbol color and point symbol color (hereafter, appropriately referred to as the “overall similarity”) will be explained. In this embodiment, the overall similarity is found based on the difference in the brightness values of all of the combinations of candidate symbol colors and point symbol colors.

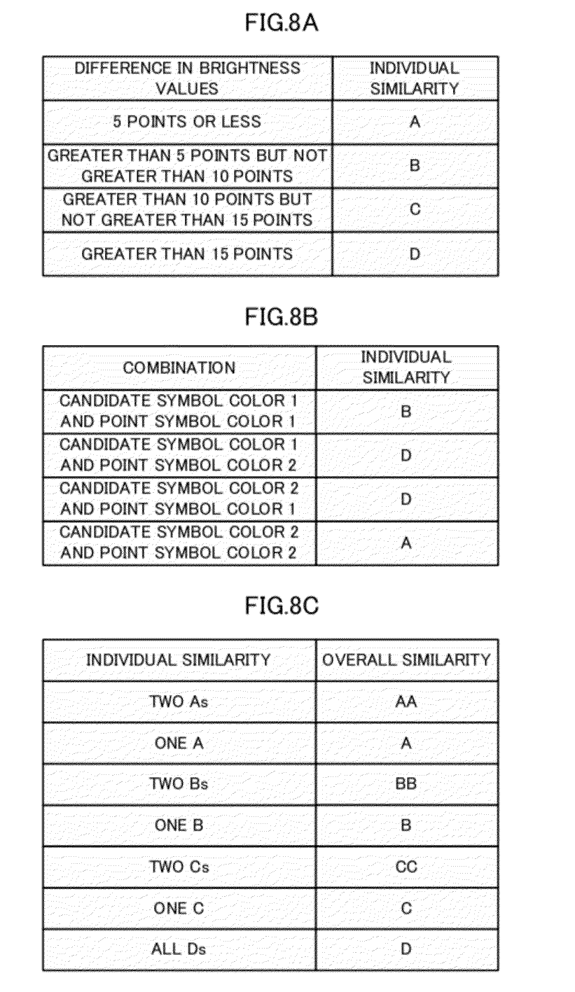

First, the differences in brightness values between the candidate symbol colors and point symbol colors are found for each component. Then, the individual similarities are found by determining the differences between the brightness values found for each component according to the judgment criteria illustrated in FIG. 8A. More specifically, the individual similarities are found as described below.

The individual similarities when arranged in order from highest are taken to be A, B, C and D

When the difference between the brightness values for the component having the largest difference in brightness values is 5 points or less, (when the difference between the brightness values of all components is 5 points or less) the individual similarity is taken to be A.

When the difference between the brightness values for the component having the largest difference in brightness values is greater than 5 points but not greater than 10 points, the individual similarity is taken to be B.

When the difference between the brightness values for the component having the largest difference in brightness values is greater than 10 points but not greater than 15 points, the individual similarity is taken to be C.

When the difference between the brightness values for the component having the largest difference in brightness values is greater than 15 points, the individual similarity is taken to be D.

In the following, the individual similarities for the case when the candidate symbol colors have the brightness values given in FIG. 7C, and the point symbol colors have the brightness values given in FIG. 7D are given in FIG. 8B. The method for finding the individual similarities will be explained in detail below.

First, for the combination of candidate symbol color 1 and point symbol color 1, the component having the largest difference between the brightness values is the G component, and the difference in the brightness value for the G component is |140−130|=10 points. Therefore, the individual similarity for the combination of candidate symbol color 1 and point symbol color 1 is B.

Next, for the combination of candidate symbol color 1 and point symbol color 2, the component having the largest difference between the brightness values is the B component, and the difference in the brightness value for the B component is |125−90|=35 points. Therefore, the individual similarity for the combination of candidate symbol color 1 and point symbol color 2 is D.

For the combination of candidate symbol color 2 and point symbol color 1, the component having the largest difference between the brightness values is the B component, and the difference in the brightness value for the B component is |85−130|=45 points. Therefore, the individual similarity for the combination of candidate symbol color 2 and point symbol color 1 is D.

For the combination of candidate symbol color 2 and point symbol color 2, the difference between the brightness values for the R component is |105−100|=5 points, the difference between the brightness values for the G component is |115−110|=5 points, and the difference between the brightness values for the B component is |85−90|=5 points, so that the difference between the brightness values for any component is five points. Therefore, the individual similarity for the combination of candidate symbol color 2 and point symbol color 2 is A.

Here, the overall similarity is found based on the individual similarity for all combinations of candidate symbol colors and point symbol colors. The overall similarity, for example, is found according to the criteria given in FIG. 8C. This is explained in detail below.

When there are two As, the overall similarity is AA, regardless of the number of Bs, Cs and Ds.

When there is one A, the overall similarity is A, regardless of the number of Bs, Cs and Ds.

When there are no As and two Bs, the overall similarity is BB, regardless of the number of Cs and Ds.

When there are no As and one B, the overall similarity is B, regardless of the number of Cs and Ds.

When there are no As and no Bs, and there are two Cs, the overall similarity is CC, regardless of the number of Ds.

When there are no As and no Bs, and there is one C, the overall similarity is C, regardless of the number of Ds.

When there are all Ds (the number of As, Bs and Cs is zero, and the number of Ds is four), the overall similarity is taken to be D.

Here, the overall similarity arranged in order from the highest is AA, A, BB, B, CC, C and D.

When the individual similarities for combinations of candidate symbol colors and point symbol colors are the results illustrated in FIG. 8B, there is one A, so that the overall similarity is A.

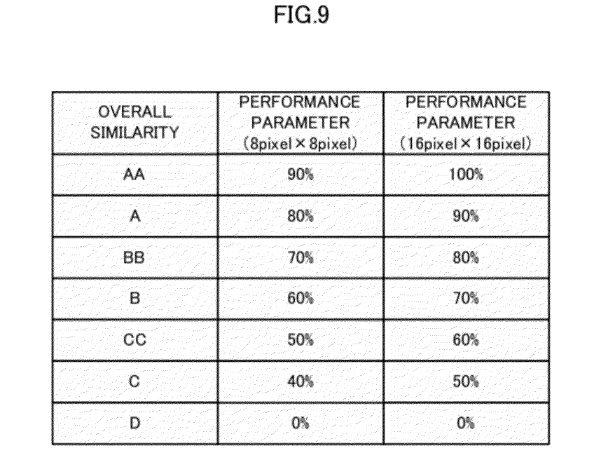

Next, the relationship between the overall similarity and the performance parameter will be explained with reference to FIG. 9.

In this embodiment, as illustrated in FIG. 9, it is defined that the higher the overall similarity is, the higher the performance parameter becomes, and the higher the level of mosaic processing (mosaic coarseness) is, the higher the performance parameter becomes. In this embodiment, the performance parameter (camouflage performance) is the probability that the enemy will not discover the character.

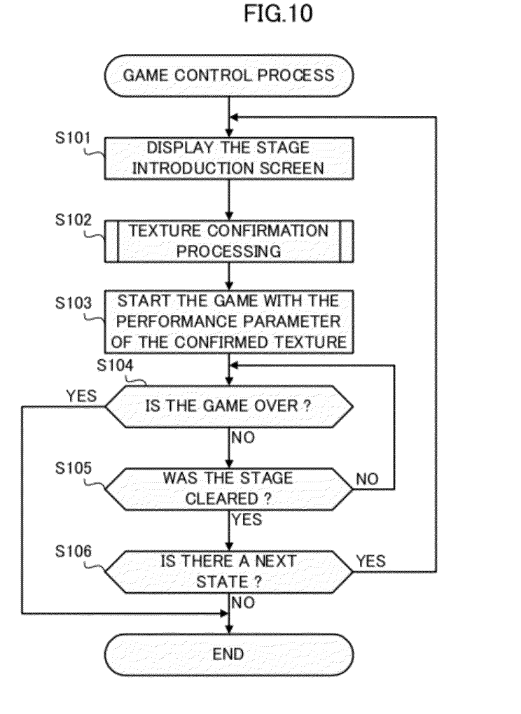

Next, the operation of the game device 300 of this embodiment will be explained with reference to FIG. 10. FIG. 10 is a flowchart of the game control process that the game device 300 of this embodiment executes. The game control process illustrated in FIG. 10, for example, is a process that is executed after an instruction to start play has been received from the user.

First, the CPU 101 displays the stage introduction screen (step S101). The stage introduction screen is a screen for presenting to the user what kind of stages there are to be challenged. For example, the stage introduction screen can be a screen that suggests the topography of the next scene (forest, field, ocean, city, and the like). On the other hand, the user, using this stage introduction screen as a reference, can select an image for generating the pattern and color of camouflaged clothes for the character to wear. The CPU 101, working together with the image processor 107, displays the stage introduction screen on the touch screen 108.

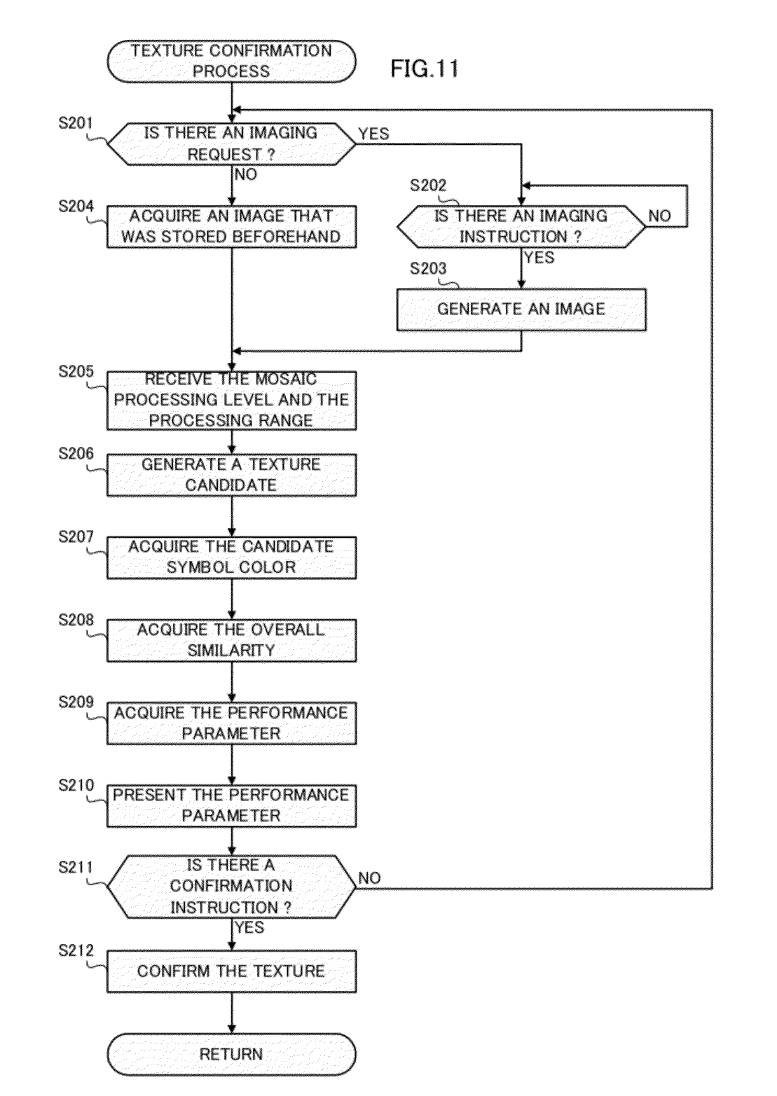

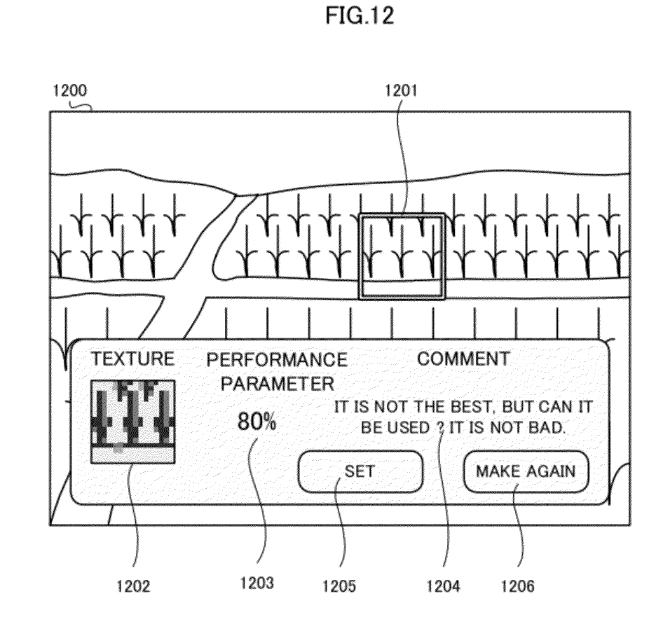

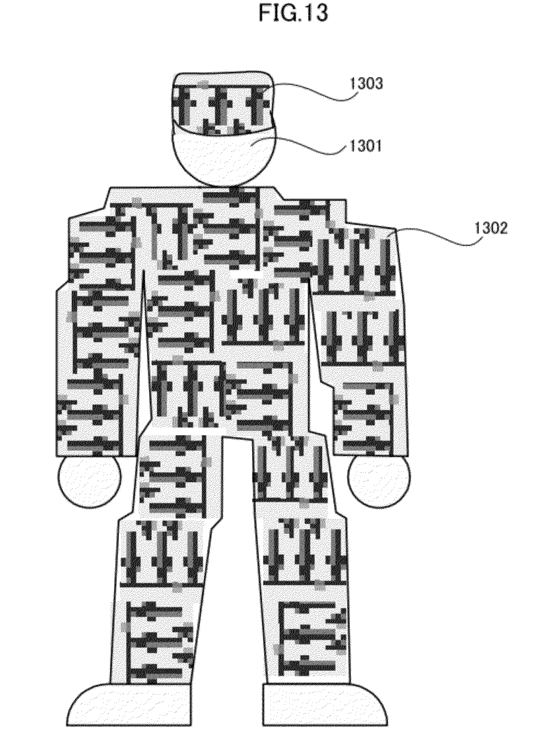

After the processing of step S101 ends, the CPU 101 executes the texture confirmation process (step S102). The texture confirmation process will be explained in detail with reference to FIG. 11.

First, the CPU 101 determines whether or not there is a request to take an image (step S201). For example, the CPU 101 determines whether or not an operation was performed using the input device 105 or touch panel 108 that corresponds to a request to take an image.

When it is determined that there is a request to take an image (step S201: YES), the CPU 101 determines whether or not there is an imaging instruction (step S202). For example, the CPU 101 determines whether or not an operation was performed using the input device 105 or touch panel 108 that corresponds to an imaging instruction. When it is determined that there is no imaging instruction (step S202: NO), the CPU 101 returns processing to step S202.

On the other hand, when it is determined that there is an imaging instruction (step S202: YES), the CPU 101 generates an image (step S203). More specifically, the CPU 101 controls the camera 114 and causes the camera 114 to take an image, then acquires the image that was taken and writes that image to RAM 103. The image that was taken can also be stored on the memory cassette 106.

When it is determined that there is no request to take an image (step S201: NO), the CPU 101 acquires an image that is already stored (step S204). For example, the CPU 101 receives a specification for an image from the user via the input device 105 or touch screen 108, and reads the image that was specified by the user from the memory cassette 106 and stores a copy in RAM 103.

After the processing of step S203 or step S204 has ended, the CPU 101 receives the mosaic processing level and processing range (step S205). More specifically, the CPU 101 controls the image processor 107 and displays an image indicating the candidates for the mosaic processing level on the touch screen 108. Then the CPU 101 receives a specification for the mosaic processing level via the input device 105 or touch screen 108. The CPU 101 then controls the image processor 107, and displays an image 1200 and image 1201 as illustrated in FIG. 12 on the touch screen 108. When a specified movement operation was performed using the input device 105 or touch panel 108, the CPU 101 causes the image 1201 to move inside the touch screen 108. Here, when a specified confirmation operation is performed using the input device 105 or touch screen 108, the CPU 101 acquires the range indicated by the image 1201 as the processing range.

After the processing of step S205 ends, the CPU 101 generates a texture candidate (step S206). The CPU 101, for example, extracts from the images written to RAM 103 by the processing in step S203 or step S204 an image that is specified by the processing range received in step S205. The CPU 101 then performs mosaic processing on the extracted image according to the mosaic processing level received in step S205. The image for which the mosaic processing was performed becomes a texture candidate.

After the processing of step S206 ends, the CPU 101 acquires the candidate symbol colors (step S207). More specifically, the CPU 101 acquires the average color of the colors of the four corner blocks of the image for which mosaic processing was performed as candidate symbol color 1, and acquires the average color of the colors of four blocks that were arbitrarily extracted from the center portion of the image for which mosaic processing was performed as candidate symbol color 2.

After the processing of step S207 ends, the CPU 101 acquires the overall similarity (step S208). More specifically, the CPU 101 finds the differences between brightness values for each component for all of the combinations of the two candidate symbol colors acquired in step S207 and the two point symbol colors that were stored beforehand on the memory cassette 106. Then, the CPU 101 finds the individual similarities for the differences between the brightness values for each component for all of the combinations. The CPU 101 then further finds the overall similarity based on the individual similarities found for all of the combinations.

After the processing of step S208 ends, the CPU 101 acquires the performance parameter (step S209). More specifically, the CPU 101 finds the performance parameter based on the level of mosaic processing that was received in step S205 and the overall similarity that was acquired in step S208. The performance parameter becomes higher the higher the level of mosaic processing is, and the higher the overall similarity is.

After the processing of step S209 ends, the CPU 101 presents the performance parameter (step S210). More specifically, the CPU 101 controls the image processor 107 and displays an image indicating the performance parameter on the touch screen 108. In the following, the image that indicates the performance parameter will be explained with reference to FIG. 12.

As illustrated in FIG. 12, the image illustrating the performance parameter can include image 1200 to image 1206.

The image 1200 is an image that was generated in step S203, or is an image that was read in step S204.

The image 1201 is an image that is part of the image 1200, and displays the processing range that was used when generating a texture candidate.

The image 1202 is an image that displays the texture candidate.

The image 1203 is an image that uses text or a numerical value to indicate the performance parameter of the texture candidate that is displayed in image 1202.

The image 1204 is an image that uses text to give comments about the performance parameter displayed in image 1203. The contents of the comment are correlated with the performance parameter and stored on the memory cassette 106.

The image 1205 is an image of a ‘set’ button that is pressed when it has been decided to use the texture candidate displayed in image 1202 as the texture to be applied to the clothing of the character.

The image 1206 is an image of a ‘redo’ button that is pressed when it has been decided to not use the texture candidate displayed in image 1202 as the texture to be applied to the clothing of the character.

It is possible for the user to reference the performance parameter displayed in image 1203 and the comment displayed in image 1204 to determine whether or not to use the texture candidate displayed in image 1202 as the texture to be applied to the clothing of the character.

After the processing of step S210 ends, the CPU 101 determines whether or not there is a confirmation instruction (step S211). More specifically, the CPU 101 determines whether or not the ‘set’ button that is displayed in image 1205 or the ‘redo’ button displayed in image 1206 was pressed with a touch pen 201. When it is detected that the ‘set’ button was pressed, the CPU 101 determines that there is a confirmation instruction, and when it is detected that the ‘redo’ button was pressed, the CPU 101 determines that there is no confirmation instruction.

When it was determined that there was no confirmation instruction (step S211: NO), the CPU 101 returns processing to step S201. However, when it was determined that there is a confirmation instruction (step S211: YES), the CPU 101 confirms the texture candidate generated in step S206 as the texture to be applied to the clothing of the character (step S212).

After the processing of step S212 ends, the CPU 101 ends the texture confirmation process.

After the processing of step S102 ends, the CPU 101 starts the game using the performance parameter of the confirmed texture. In other words, after the texture has been confirmed, the CPU 101 applies that texture to the character and starts the game. Here, in that state, the CPU 101 uses the performance parameter of the texture that was applied to determine whether or not the enemy discovers the character.

FIG. 13 illustrates the state of the texture applied to the clothing of the character. FIG. 13 illustrates an example wherein a texture 1302 and a texture 1303 are applied to the clothing of the character 1301. Here, the texture 1302 is a texture that expresses camouflaged clothes, with the pattern and color being the same as that in image 420. That is, the texture 1302 is generated by rotating, arranging and combining the image 420. The texture 1303 is a texture that expresses a camouflaged hat, and has the same pattern and color as that of texture 1302.

After the processing of step 103 ends, the CPU 101 determines whether or not the game is over (step S104). When it is determined that the game is over (step S104: YES), the CPU 101 ends the game control process. On the other hand, when it is determined that the game is not over (step S104: NO), the CPU 101 determines whether or not the stage was cleared (step S105).

When it is determined that the stage is not cleared (step S105: NO), the CPU 101 returns processing to step S104. However, when it is determined that the stage is cleared (step S105: YES), the CPU 101 determines whether or not there is a next stage (step S106).

When it is determined that there is a next stage (step S106: YES), the CPU 101 returns processing to step S101. On the other hand, when it is determined that there is no next stage (step S106: NO), the CPU 101 ends the game control process.

With the game device 300 of this embodiment, the user can freely generate texture to be applied to a character based on an image taken with a camera and while referencing a performance parameter. The texture that is generated is the image that was taken that has undergone mosaic processing, so that it is possible to suppress the generation of texture having an unsuitable pattern. Furthermore, the performance parameter becomes higher the higher the level of mosaic processing is, so it is possible to further suppress the generation of texture having an unsuitable pattern.

### Embodiment 2

In the first embodiment, an example was giving of controlling the game based on texture that the game device 300 generated. However, it is also possible for the game device 300 to control the game based on texture that was generated by an external device. In the following, the game device 320 of this embodiment will be explained.

The game device 320 is achieved by mounting a specified memory cassette 106 in the slot of an information processing device 100 and turning the power to the information processing device 100 ON. In other words, the physical construction of the game device 320 is the same as that of the game device 300 of the first embodiment.

### Explanation of the Game System

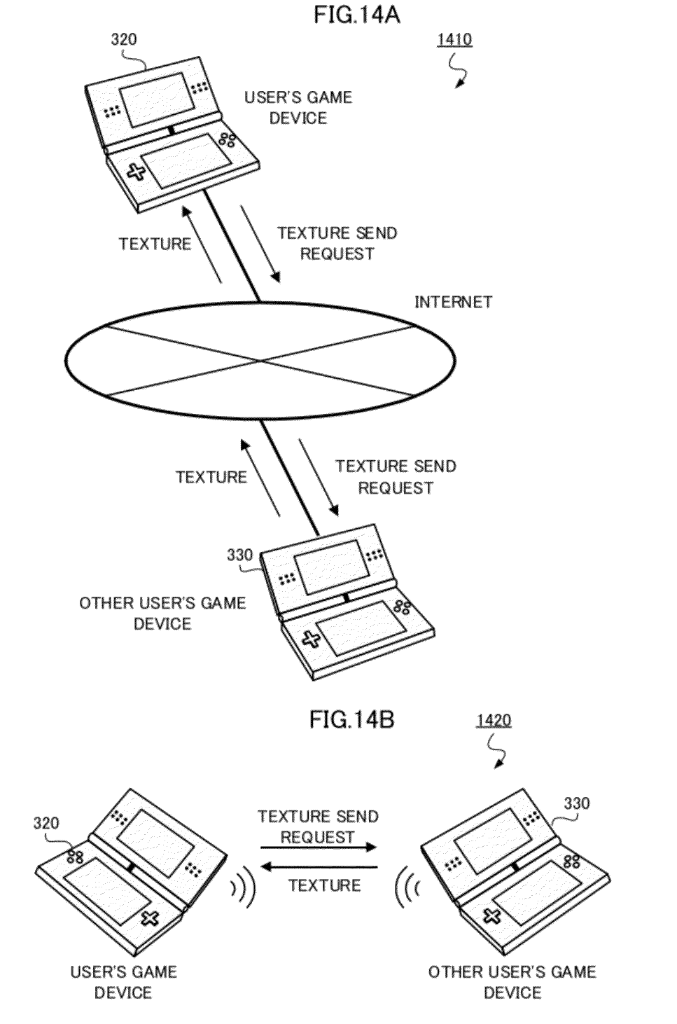

First, an overview of a game system that includes the game device 320 of this embodiment is explained with reference to FIGS. 14A and 14B. As the game system, a game system 1410 that makes possible infrastructure communication (infrastructure communication mode) as illustrated in FIG. 14A can be employed, or a game system 1420 that makes possible ad hoc communication (ad hoc communication mode) as illustrated in FIG. 14B can be employed.

As illustrated in FIG. 14A, the game system 1410 comprises a game device 320 and a game device 330 that are connected together via a computer communication system such as the Internet. The game system 1410 can also comprise a game server (not illustrated in the figure). The game device 320 and the game device 330 basically have the same construction and same functions. In this embodiment, an example will be explained wherein the game device 320 that is used by the user acquires images from the game device 330 that is used by another user.

The game device 320 sends a request to the game device 330 to send texture. When the game device 330 receives a request to send texture from the game device 320, the game device 330 sends information identifying texture candidates that can be sent to the game device 320. The game device 320 presents the candidates identified by the received information to the user, and receives a texture specification from the user for texture desired by the user. The game device 320 then sends information identifying the texture that was specified by the user to the game device 330. Here, the game device 330 sends the texture that was specified by the received information to the game device 320.

The game device 320, for example, can perform communication with the game device 330 using the NIC 109. Moreover, the procedure for receiving texture in the game system 1430 is basically the same as the procedure for receiving texture in the game system 1410, except that texture is received directly and not via the Internet.

### Explanation of the Game Device

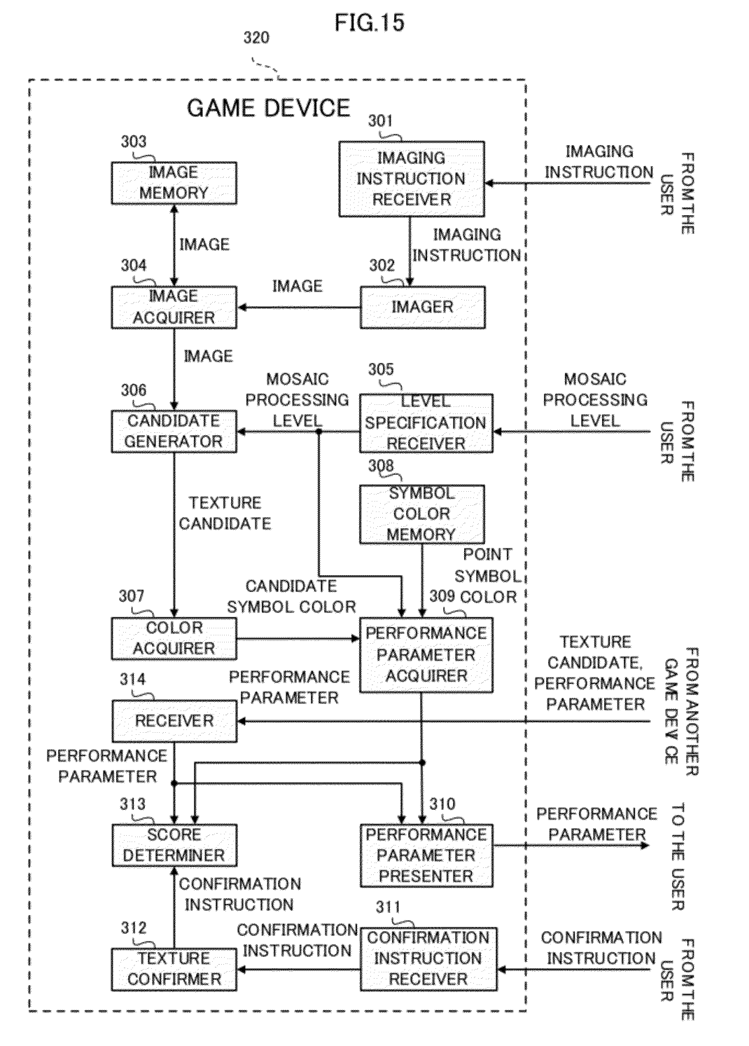

Next, the functions of the game device 320 of this embodiment will be explained with reference to the drawings. First, the construction of the game device 320 of this embodiment of the present invention will be explained with reference to FIG. 15.

As illustrated in FIG. 15, the game device 320 comprises an imaging instruction receiver 301, an imager 302, an image memory 303, an image acquirer 304, a level specification receiver 305, a candidate generator 306, a color acquirer 307, a symbol color memory 308, a performance parameter acquirer 309, a performance parameter presenter 310, a confirmation instruction receiver 311, a texture confirmer 312, a score determiner 313, and a receiver 314. An explanation of construction of the game device 320 that is the same as the construction of the game device 300 will be appropriately omitted.

The receiver 314 receives a texture candidate and the performance parameter found for that texture candidate from the other game device 330 by ad hoc communication or infrastructure communication. The texture candidate and the performance parameter for that texture candidate are generated by the other game device 330. The receiver 314, for example, comprises a NIC 109.

Here, the performance parameter presenter 310 presents the received performance parameter to the user. The performance parameter presenter 310, for example, can comprise the CPU 101, image processor 107 and touch screen 108, or can comprise the CPU 101, audio processor 110 and speaker 112.

After receiving a confirmation instruction, the texture confirmer 312 confirms the received texture candidate as the texture to be applied to the clothing of the character. The texture confirmer 312, for example, comprises the CPU 101.

Here, a texture candidate that can be received by the receiver 314 is limited to a texture candidate whose performance parameter for that texture candidate is higher than a threshold value. In other words, the receiver 314 does not receive texture candidates whose performance parameter is equal to or less than a specified threshold value. For example, when the performance parameter is set to be lower the lower the mosaic processing level is, it becomes difficult for a texture candidate for which the mosaic processing level is low to be received. With this construction, it is possible to suppress the reception of texture candidates having an unsuitable pattern.

Moreover, when the receiver 314 receives a texture candidate through infrastructure communication, the specified threshold value can be set higher than when the receiver 314 receives a texture candidate though ad hoc communication. With this construction, in infrastructure communication where texture candidates are received by an unspecified number of users, it is possible to suppress the reception of a texture candidate having an unsuitable pattern.

The receiver 314 also receives information that identifies the user of the game device 330, which is the sender of the texture candidate. Here, when the user that is indicated by the received information is not a user that was set beforehand, the specified threshold value is set higher than when the user indicated by the received information is a user that was set beforehand. With this construction, the game device 320 can suppress the reception of a texture candidate that has an unsuitable pattern that is sent from an unknown user.

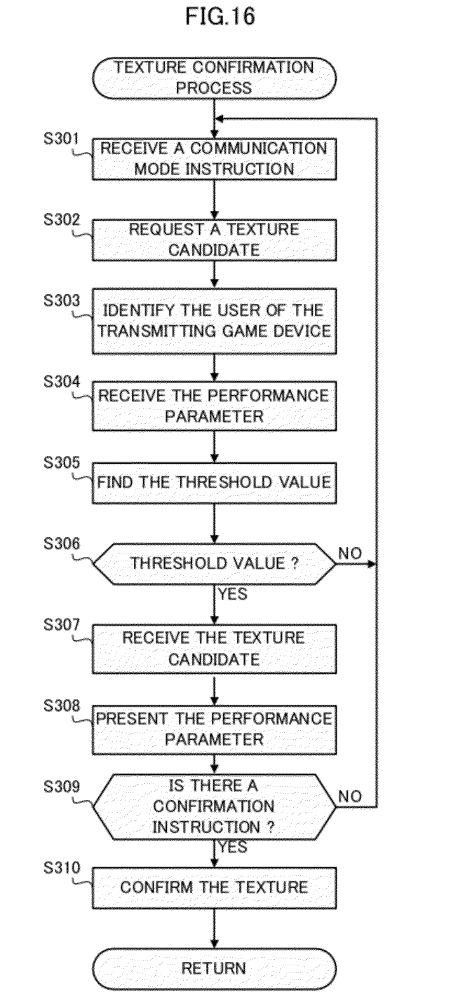

Next, the game control process that is executed by the game device 320 of this embodiment will be explained. Here, the game control process that is executed by the game device 320 is basically the same as the game control process that is executed by the game device 300 except for the texture confirmation process. In the following, the texture confirmation process that is executed by the game device 320 is explained with reference to FIG. 16.

First, the CPU 101 receives a communication mode specification (step S301). For example, the CPU 101 receives a specification via the input device 105 or touch screen 108 for the communication mode, infrastructure communication or ad hoc communication, by which communication will be performed.

After the processing of step S301 ends, the CPU 101 requests a texture candidate (step S302). For example, the CPU 101 request a list from the game device 330 of textures generated by the game device 330, and receives the list that is sent from the game device 330. The CPU 101 then presents the received list to the user, and receives a specification from the user of the desired texture from among the textures in the list. Next, the CPU 101 sends information to the game device 330 identifying the texture specified by the user.

After the processing of step S302 has ended, the CPU 101 identifies the user of the game device 330 that is the sender (step S303). For example, the CPU 101 receives information identifying the user of the game device 330 from the game device 330.

After the processing of step S303 has ended, the CPU 101 receives a performance parameter (step S304). In other words, before receiving the texture candidate from the game device 330, the CPU 101 receives the performance parameter that was found for that texture candidate from the game device 330.

After the processing of step S304 has ended, the CPU 101 finds a threshold value based on the communication mode received in step S301 and the classification of the user identified in step S303 (step S305). More specifically, when the received communication mode is the infrastructure mode, the threshold value is set higher than when the communication mode is the ad hoc mode. Moreover, when the identified user is not a registered user, the threshold value is set higher than when the user is a registered user. The information indicating that the user is a registered user can, for example, be stored beforehand on the memory cassette 106.

After the processing of step S305 has ended, the CPU 101 determines whether or not the performance parameter that was received in step S304 is equal to or greater than the threshold value that was found in step S305 (step S306).

When it is determined that the performance parameter is not equal to or greater than the threshold value (step S306: NO), the CPU 101 returns processing to step S301. However, when it is determined that the performance parameter is equal to or greater than the threshold value (step S306: YES), the CPU 101 receives a texture candidate from the game device 330 (step S307).

After the processing of step S307 has ended, the CPU 101 presents the performance parameter (step S308). More specifically, the CPU 101 controls the image processor 107, and displays an image indicating the performance parameter on the touch screen 108.

After the processing of step S308 has ended, the CPU 101 determines whether or not there is a confirmation instruction (step S309). More specifically, the CPU 101 determines whether or not the ‘set’ button that is displayed in image 1205 or the ‘redo’ button that is displayed in image 1206 has been pressed with a touch pen 201. When it was detected that the ‘set’ button was pressed, the CPU 101 determines that there is a confirmation instruction, and when it was detected that the ‘redo’ button was pressed, the CPU 101 determines that there is no confirmation instruction.

When it was determined that there is no confirmation instruction (step S309: NO), the CPU 101 returns processing to step S301. However, when it was determined that there is a confirmation instruction (step S309: YES), the CPU 101 confirms the texture candidate that was received in step S307 as the texture to be applied to the clothing of the character (step S310).

After the processing of step S310 has ended, the CPU 101 ends the texture confirmation process.

With the game device 320 of this embodiment, it is possible to receive suitable texture; however, it is also possible to suppress the reception of unsuitable texture. Unsuitable texture, for example, is texture having a low level of mosaic processing, texture that was sent from an unidentified user, or texture that was sent from an unregistered user.

### Variations

The present invention is not limited to the embodiments above, and various variations are possible.

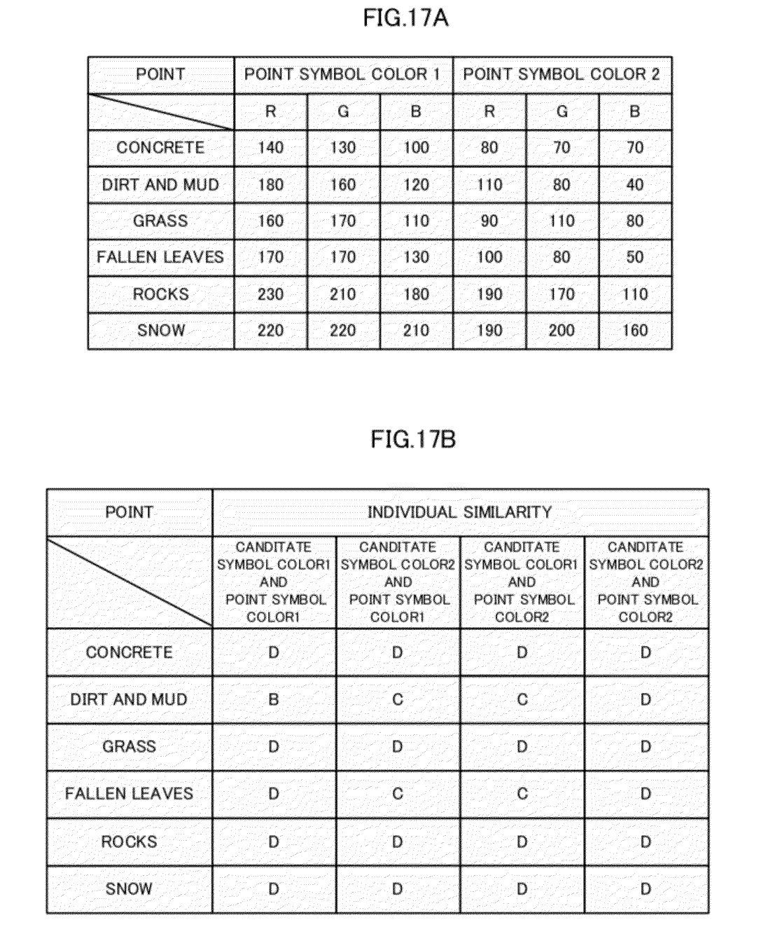

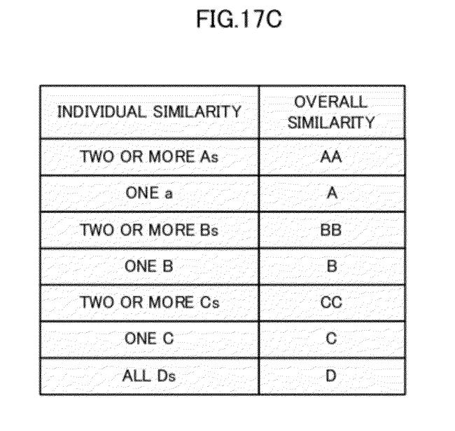

In the embodiments above, examples were given in which one point in virtual space (background) in one stage was of interest. However, in the present invention, it is possible for a plurality of points in virtual space in one stage to be of interest. In that case, individual similarities between point symbol colors and candidate symbol colors are found for each of the plurality of points in one stage, and the overall similarity is determined based on the individual similarities that were found. In the following, this will be explained in detail with reference to FIGS. 17A to 17C.

First, as illustrated in FIG. 17A, point symbol colors are set for each point. As in the embodiments above, there are two point symbol colors; point symbol color 1 and point symbol color 2. Next, for each point, individual similarities are found for all combinations of the point symbol colors and candidate symbol colors. FIG. 17B illustrates the individual similarities that were found for each point. The overall similarity is then found based on the individual similarities that were found for each point. FIG. 17C illustrates the relationship between the individual similarities and the overall similarities.

In this way, by collectively determining the individual similarities between each of the point symbol colors of the various kinds of points in one stage and the candidate symbol colors of the texture candidates, the texture performance of the texture candidates of that stage can be appropriately determined.

In the embodiments above, examples were given wherein the number of point symbol colors was two, and the number of candidate symbol colors was two. However, the number of point symbol colors can be one, or three or more. Moreover, the number of candidate symbol colors can be one, two, three or more. It is also possible to appropriately adjust how the point symbol colors and candidate symbol colors are defined.

For example, instead of the candidate symbol color being a color that is expressed by the average value of the brightness values of a plurality of pixels, it can be a color that is expressed by the brightness value of a specified pixel (specified pixel color). More specifically, a candidate symbol color can be the color of a pixel in an image that was determined beforehand, or can be the color of a pixel in an image that was selected at random.

In the embodiments above, example were given wherein the point symbol colors and candidate symbol colors were expressed as brightness values of the three primary colors R, G and B. However, the point symbol colors and candidate symbol colors can also be expressed using monochrome brightness values.

In the embodiments above, examples were given wherein an area for which mosaic processing was performed (source area for the texture candidate) was extracted from an image that was taken. However, it is possible to perform mosaic processing for the entire image that was taken and use the entire image that was taken to be the source of the texture candidate.

In the embodiments above, examples were given wherein individual similarities were set based on the differences between brightness values of components having the largest differences in brightness values of the differences between the brightness values of point symbol colors and the brightness values of candidate symbol colors. However, the method of setting individual similarities can be appropriately adjusted. For example, individual similarities can be set based on the total of the differences between the brightness values of point symbol colors and the brightness values of candidate symbol colors that were found for each component.

In the embodiments above, examples were given wherein the overall similarity was set based on the number of highest individual similarities. However, the method for setting the overall similarity can be appropriately adjusted. For example, it is possible to set the overall similarity to be lower than when there is one A and one D, when there are two Bs, or when there is one B and one C.

In the embodiments above, examples were given wherein mosaic processing is a process of dividing an image into a plurality of blocks, and taking the brightness values of all of the pixels included in one block after division to be the average value of the brightness values of all of the pixels included in that block. However, it is possible to appropriately adjust what kind of process mosaic processing is. For example, in mosaic processing, it is possible to use weighted averages instead of simple averages.

In the embodiments above, examples were explained wherein the performance parameter was the probability that the enemy would not discover the character. However, what to use as the performance parameter can be appropriately adjusted. Preferably, something that is related to the degree of familiarity with the appearance of the character and the objects around the character is used as the performance parameter.

For example, in an action game in which a character infiltrates into an enemy stronghold, the performance parameter can be the character's ability to defend against attack (enemy attack by guns, sword, bare hands and the like. Here, an enemy can be anything not human such as machine, animal or plant.) (ability to avoid attack or difficulty of receiving damage), the character's ability to resist heat (or resist cold), the character's ability to maintain physical strength and the like.

Moreover, for example, in a game in which a character dances or sings on a stage, the performance parameter could be the degree of being fashionable.

Furthermore, for example, in a game wherein a city is created by building a building character in a city, the performance parameter could be the degree of harmony of the building character with the city, or the amount of improvement of the attractiveness of the city.

In the embodiments above, examples were given wherein the present invention was applied to a game device that is special for just controlling a game. However, the present invention can also be applied to a personal computer or mobile phone that additionally comprises a function for controlling a game.

### INDUSTRIAL APPLICABILITY

As was explained above, the present invention can provide a game device, which allows the appearance of a character in virtual space to be that of an image taken by a camera, a game control method, and a non-transitory information recording medium on which is recorded a computer readable program that makes the game device and game control method possible by way of a computer.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A game device comprising:
an image acquirer that acquires an image taken by a camera;
a candidate generator that generates an image for which mosaic processing has been performed on the acquired image, and designates the generated image as a candidate for a texture to be applied to a character in virtual space;
a color acquirer that acquires a color that symbolizes the candidate for the texture;
a performance parameter acquirer that finds a performance parameter for the texture candidate from the similarity between the acquired color and a color that symbolizes a point of interest in the virtual space;
a performance parameter presenter that presents the performance parameter that was found to a user;
a confirmation instruction receiver that receives a confirmation instruction from the user; and
a texture confirmer that, when the confirmation instruction is received, confirms the texture candidate as the texture to be applied to a clothing of the character.

2. The game device according to claim 1, further comprising
a score determiner that determines the game score based on the performance parameter that was found for the confirmed texture.

3. The game device according to claim 1, further comprising;
an imaging instruction receiver that receives an imaging instruction from the user; and
an imager that takes an image according to the received imaging instruction; wherein
the image acquirer acquires the image that was taken.

4. The game device according to claim 1, wherein
the performance parameter acquirer finds the performance parameter based on the similarity and the level of mosaic processing.

5. The game device according to claim 4, wherein
the level of mosaic processing is set based on the difference in clarity of the acquired image and the generated image.

6. The game device according to claim 1, further comprising
a level specification receiver that receives a specification from the user for the level of the mosaic processing; wherein
the candidate generator generates an image for which mosaic processing has been performed on the acquired image according to the received level specification.

7. The game device according to claim 1, further comprising
a receiver that receives the texture candidate and performance parameter that was found for that texture candidate from another game device by ad hoc communication or infrastructure communication; wherein
the performance parameter presenter presents the received performance parameter to the user; and
the texture confirmer, when the confirmation instruction is received, confirms the received texture candidate as the texture to be applied to the clothing of the character.

8. The game device according to claim 7, wherein
the texture candidate that can be received by the receiver is limited to a texture candidate whose performance parameter that was found for that texture candidate is higher than a specified threshold value.

9. The game device according to claim 8, wherein
the specified threshold value is set to be higher when the receiver receives the texture candidate by infrastructure communication compared to when the receiver receives the texture candidate by ad hoc communication.

10. The game device according to claim 8, wherein
the receiver further receives information that identifies the user of the game device that is the source that sends the texture candidate; and
the specified threshold value is set higher when the user that is indicated by the received information is not a preset user compared to when the user that is indicated by the received information is a preset user.

11. A game control method that is executed by a game device comprising an image acquirer, a candidate generator, a color acquirer, a performance parameter acquirer, a performance parameter presenter, the confirmation instruction receiver, and a texture confirmer, comprising:
an image acquisition step wherein the image acquirer acquires an image taken by a camera;
a candidate generation step wherein the candidate generator generates an image for which mosaic processing has been performed on the acquired image, and designates the generated image as a candidate for a texture to be applied to a character in virtual space;
a color acquisition step wherein the color acquirer acquires a color that symbolizes the texture candidate;
a performance parameter acquisition step wherein the performance parameter acquirer finds a performance parameter for the texture candidate from the similarity between the acquired color and a color that symbolizes a point of interest in the virtual space;
a performance parameter presentation step wherein the performance parameter presenter presents the performance parameter that was found to a user;
a confirmation instruction receiving step wherein the confirmation instruction receiver receives a confirmation instruction from the user; and
a texture confirmation step wherein, when the confirmation instruction is received, the texture confirmer confirms the texture candidate as the texture to be applied to a clothing of the character.

12. A non-transitory information recording medium on which a computer readable program is recorded that causes a computer comprising a confirmation instruction receiver that receives a confirmation instruction from a user to function as:
an image acquirer that acquires an image taken by a camera;
a candidate generator that generates an image for which mosaic processing has been performed on the acquired image, and designates the generated image as a candidate for a texture to be applied to a character in virtual space;
a color acquirer that acquires a color that symbolizes the texture candidate;
a performance parameter acquirer that finds a performance parameter for the texture candidate from the similarity between the acquired color and a color that symbolizes a point of interest in the virtual space;
a performance parameter presenter that presents the performance parameter that was found to a user; and
a texture confirmer that, when the confirmation instruction is received, confirms the texture candidate as the texture to be applied to a clothing of the character.
